(19) United States
(12) Patent Application Publication
(10) Pub. No.: US 2025/0225783 A1
(43) Pub. Date: Jul. 10, 2025

(54) IMAGE QUALITY DETECTION METHOD AND APPARATUS, COMPUTER DEVICE, AND STORAGE MEDIUM

(71) Applicant: Tencent Technology (Shenzhen) Company Limited, Shenzhen (CN)

(72) Inventor: Xudong YAN, Shenzhen (CN)

(73) Assignee: Tencent Technology (Shenzhen) Company Limited, Shenzhen (CN)

(21) Appl. No.: 19/092,189

(22) Filed: Mar. 27, 2025

Related U.S. Application Data
(63) Continuation of application No. PCT/CN2024/078529, filed on Feb. 26, 2024.

(30) Foreign Application Priority Data
Mar. 29, 2023 (CN) 202310355792.3

(51) Int. Cl. G06V 10/98; G06V 10/25; G06V 10/44; G06V 10/74; G06V 10/75; G06V 10/764; G06V 10/774; G06V 10/80

(52) U.S. Cl. CPC G06V 10/993; G06V 10/25; G06V 10/44; G06V 10/751; G06V 10/761; G06V 10/764; G06V 10/774; G06V 10/806

(57) ABSTRACT

An image quality detection method includes, obtaining an input image; recognizing a target element in an input image, and obtaining a target element region of the input image in which the target element is located; extracting a current region feature corresponding to the target element region; obtaining category features corresponding to preset image quality categories; comparing the current region feature with the category features, to obtain matching degrees between the current region feature and the category features, and determining a target category feature corresponding to the current region feature from the category features based on the matching degrees; and determining a target region quality category of the target element region based on a target preset image quality category corresponding to the target category feature, and outputting a predicted image quality category of the input image based on the target region quality category.

### CROSS-REFERENCE TO RELATED APPLICATIONS

This application is a continuation application of International Application No. PCT/CN2024/078529 filed on Feb. 26, 2024, which claims priority to Chinese Patent Application No. 202310355792.3 filed with the China National Intellectual Property Administration on Mar. 29, 2023, the disclosures of each being incorporated by reference herein in their entireties.

### FIELD

The disclosure relates to the field of computer technologies, and to an image quality detection method and apparatus, a computer device, a storage medium, and a computer program product.

### BACKGROUND

With the development of computer vision technologies, image processing technologies emerge. Currently, during image processing, an image may be collected first, and then subsequent task processing is performed on the image. Quality of collected images may differ greatly. For example, some images may include high definition and high quality, and some images may include low definition and poor quality. The quality of a collected image may be determined, and subsequent task processing can be performed only after an image with poor quality is screened out. Image quality may be detected by using a preset image quality indicator. The image quality indicator may be a peak signal-to-noise ratio, a Fourier spectrum analysis, a structural similarity index, or the like. When image quality detection is performed based on the image quality indicator, however, an image with low definition may be incorrectly determined as an image of high quality, resulting in erroneous classification.

### SUMMARY

According to an aspect of the disclosure, an image quality detection method includes, obtaining an input image; recognizing a target element in the input image, and obtaining a target element region of the input image in which the target element is located; extracting a current region feature corresponding to the target element region; obtaining a plurality of category features corresponding to a plurality of preset image quality categories, wherein obtaining a category feature includes performing feature extraction on a plurality of preset reference element images belonging to a preset image quality category to obtain a plurality of reference element image features; and fusing the plurality of reference element image features to obtain the category feature; comparing the current region feature with the plurality of category features, to obtain a plurality of matching degrees between the current region feature and the plurality of category features, and determining a target category feature corresponding to the current region feature from the plurality of category features based on the plurality of matching degrees; and determining a target region quality category of the target element region based on a target preset image quality category corresponding to the target category feature, and outputting a predicted image quality category of the input image based on the target region quality category.

According to an aspect of the disclosure, an image quality detection apparatus includes, at least one memory configured to store computer program code; and at least one processor configured to read the program code and operate as instructed by the program code, the program code includes region recognition code configured to cause at least one of the at least one processor to obtain an input image; and recognize a target element in the input image, and obtain a target element region of the input image in which the target element is located; feature extraction code configured to extract a current region feature corresponding to the target element region; category feature obtaining code configured to cause at least one of the at least one processor to obtain a plurality of category features corresponding to a plurality of preset image quality categories, wherein a category feature is obtained by performing feature extraction on a plurality of preset reference element images of a preset image quality category to obtain a plurality of reference element image features; and fusing the plurality of reference element image features to obtain the category feature; feature matching code configured to cause at least one of the at least one processor to compare the current region feature with the plurality of category features, to obtain a plurality of matching degrees between the current region feature and the plurality of category features, and determine a target category feature corresponding to the current region feature from the plurality of category features based on the plurality of matching degrees; and quality category determining code configured to cause at least one of the at least one processor to determine a target region quality category of the target element region based on a target preset image quality category corresponding to the target category feature, and output a predicted image quality category of the input image based on the target region quality category.

According to an aspect of the disclosure, a non-transitory computer-readable storage medium, storing computer code which, when executed by at least one processor, causes the at least one processor to at least obtain an input image; recognize a target element in the input image, and obtain a target element region of the input image in which the target element is located; extract a current region feature corresponding to the target element region; obtain a plurality of category features corresponding to a plurality of preset image quality categories, wherein a category feature is obtained by performing feature extraction on a plurality of preset reference element images of a preset image quality category to obtain a plurality of reference element image features; and fusing the plurality of reference element image features to obtain the category feature; compare the current region feature with the plurality of category features, to obtain a plurality of matching degrees between the current region feature and the plurality of category features, and determine a target category feature corresponding to the current region feature from the plurality of category features based on the plurality of matching degrees; and determine a target region quality category of the target element region based on a preset image quality category corresponding to the target category feature, and output a predicted image quality category of the input image based on the target region quality category.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a diagram of an application environment of an image quality detection method according to some embodiments.

FIG. 2 is a schematic flowchart of an image quality detection method according to some embodiments.

FIG. 3 is a schematic diagram of images of different quality categories according to some embodiments.

FIG. 4 is a schematic architectural diagram of a reference feature extraction model according to some embodiments.

FIG. 5 is a schematic flowchart of training to obtain a reference feature extraction model according to some embodiments.

FIG. 6 is a schematic framework diagram of recognizing a target element according to some embodiments.

FIG. 7 is a schematic diagram of a model structure of a target element detection model according to some embodiments.

FIG. 8 is a schematic diagram of proposal generation according to some embodiments.

FIG. 9 is a schematic flowchart of determining a target reference region feature according to some embodiments.

FIG. 10 is a schematic framework diagram of an image quality detection model according to some embodiments.

FIG. 11 is a schematic flowchart of obtaining an image quality detection model through training according to some embodiments.

FIG. 12 is a schematic flowchart of an image quality detection method according to some embodiments.

FIG. 13 is a schematic architectural diagram of an image quality detection method according to some embodiments.

FIG. 14 is a schematic framework diagram of image quality detection according to some embodiments.

FIG. 15 is a schematic diagram of images of signs according to some embodiments.

FIG. 16 is a structural block diagram of an image quality detection apparatus according to some embodiments.

FIG. 17 is a diagram of an internal structure of a computer device according to some embodiments.

FIG. 18 is a diagram of an internal structure of a computer device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

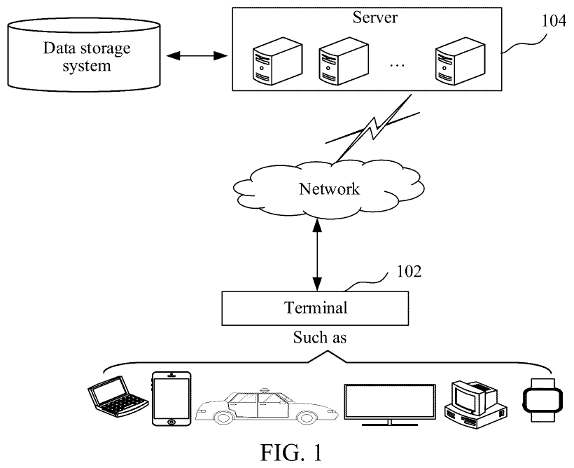

An image quality detection method provided in some embodiments may be applied to an application environment shown in FIG. 1. A terminal 102 communicates with a server 104 through a network. A data storage system may store data that the server 104 may process. The data storage system may be integrated on the server 104, or may be deployed on the cloud or on another server. The server 104 may obtain an input image uploaded by the terminal 102, and recognize a target element in the input image, to obtain a target element region in which the target element is located in the input image; extract a current region feature corresponding to the target element region, and obtain reference region features corresponding to quality categories, where the reference region features are obtained by respectively performing feature extraction on reference element regions of a corresponding quality category, to obtain reference element region features, and fusing the reference element region features; determine a target reference region feature corresponding to the current region feature from the reference region features corresponding to the quality categories based on a matching degree between the current region feature and each reference region feature corresponding to each quality category; and use a quality category corresponding to the target reference region feature as a region quality category corresponding to the target element region, and determine, based on a region quality category of the target element region, the image quality category corresponding to the input image. The terminal may be, but is not limited to, various desktop computers, notebook computers, smartphones, tablet computers, Internet of Things devices, and portable wearable devices. The Internet of Things device may be smart a speaker, a smart television, a smart air conditioner, a smart in-vehicle device, and the like. The portable wearable device may be a smart watch, a smart band, a head-mounted device, or the like. The server may be an independent physical server, a server cluster or a distributed system including a plurality of physical servers, or a cloud server providing a cloud computing service. The terminal and the server may be directly or indirectly connected in a wired or wireless communication manner. However, the disclosure is not limited thereto herein.

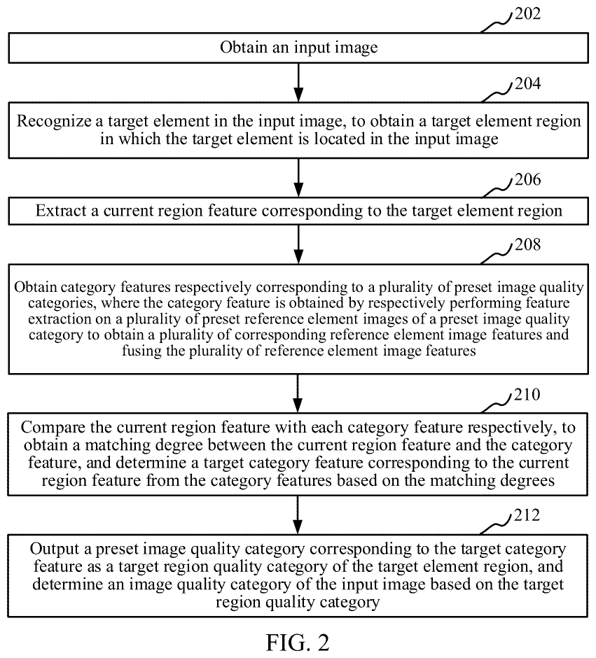

In some embodiments, as shown in FIG. 2, an image quality detection method is provided. An example in which the method is applied to the server in FIG. 1 is used for description. The method may also be applied to a terminal, or may be applied to a system including a terminal and a server, and is implemented through interaction between the terminal and the server. In some embodiments, the method includes the following operations.

202: Obtain an input image.

204: Recognize a target element in the input image, to obtain a target element region in which the target element is located in the input image.

The input image is an image on which image quality detection may be performed. The image quality is configured for representing a capability of the image of providing information for a person or a machine. For example, the image quality may be indicated by a clear degree of the image, may be represented by a distortion degree of the image, or may be represented by a blurry degree of the image. Better image quality indicates a higher clear degree of the image, a clearer image, and more information provided for a person or a machine. Poorer image quality indicates a lower clear degree of the image, a blurrier image, and less information provided for a person or a machine. The image quality is directly proportional to a clear degree of the image. The clear degree of the image means a clear degree of each detailed shadow and line and boundaries thereof on the image, and may be a clear degree of the image macroscopically seen by human eyes. The image quality is inversely proportional to a blurry degree of the image. The distortion degree of the image is a degree of difference between the image and a real environment corresponding to the image. A higher distortion degree of the image indicates poorer image quality. On the contrary, a lower distortion degree of the image indicates better image quality. The target element is configured for representing an object in an image. The object may be any real object, or may be a virtual object. The real object may be a person, an item, an animal, or the like. The virtual object may be a virtual person, a virtual item, a virtual animal, or the like. The object may be an object of interest, a key object, or the like in the image. Images collected in different scenarios are different, and target elements in the images are different. For example, in a map application scenario, the input image may be a road image, and the target element may be a physical point image region on the road, for example, a traffic restriction intersection image region, a speed limiting brand sign region, or an electronic eye image region. In a facial recognition application scenario, the input image may be a face image, and the target element may be a face. In an animal recognition application scenario, the input image may be an animal image, and the target element may be an animal. The target element region is a region of the target element in the input image. The target element region may be a region of interest in the image. The region of interest is a pixel region defined in the image, is a region that may be processed and that is delineated by using a box, an ellipse, an irregular polygon, or the like from a processed image, and may be a key pixel region in the image.

The server may obtain the input image from a database. The server may obtain the input image collected and uploaded by the terminal. The server may obtain the input image from a serving party providing a business service. The server may obtain the input image from a serving party providing a data service. The server may directly obtain the input image collected by an image collecting device. The image collecting device is a device that collects an image, and may be a monitor camera, a video camera, a photo camera, or the like. The server then recognizes the target element in the input image by using the neural network, and extracts a region in which the target element is located from the input image, to obtain the target element region in which the target element is located in the input image. A feature of the input image may be extracted, and region of interest recognition is performed based on the feature of the input image, to obtain the target element region in which the target element is located in the input image.

In some embodiments, the server may obtain a video on which image quality detection may be performed, and then use each frame in the video as the input image. The server may extract a key frame in the video, and then use the key frame as the input image.

206: Extract a current region feature corresponding to the target element region.

208: Obtain category features respectively corresponding to a plurality of preset image quality categories, where the category feature is obtained by respectively performing feature extraction on a plurality of preset reference element images of a preset image quality category to obtain a plurality of corresponding reference element image features and fusing the plurality of reference element image features.

The current region feature is a feature vector configured for representing the target element region; or may be a feature map configured for representing the target element region, and may be obtained by extracting semantic information of the target element region. The preset image quality category is a category to which preset image quality belongs. Different image quality corresponds to different categories. For example, the image quality is clear image, and a corresponding quality category is a clear image category. The image quality is blurry image, and a corresponding quality category is a blurry image category. When image quality is in an intermediate state between the clear image and the blurry image, a corresponding quality category may be an intermediate category. Different images may belong to the same quality category, or may belong to different quality categories. The image quality of the image is blurry image and may be obtained by pre-marking the image quality of the image. For example, the image is marked as blurry image based on human experience and belongs to the blurry image category. The server may perform calculations based on an image quality evaluation index, to obtain an image quality evaluation index value, determine, based on preset ranges of image quality evaluation index values corresponding to different image quality categories, a range of image quality evaluation index values that the image quality evaluation index value of the image is in, and determine the image quality of the image based on the image quality category of the range of image quality evaluation index values. The image quality evaluation index may be a clear degree of the image, a blurry degree of the image, a distortion degree of the image, or the like. For example, an image with a clear image degree greater than 100 may be determined to be of the clear image category, and an image with a clear image degree less than or equal to 100 may be determined to be of the blurry image category. The image quality evaluation index may be an evaluation index based on image pixel statistics. For example, a peak signal-to-noise ratio (PSNR) and a mean square error of an image may be calculated to determine the image quality evaluation index value, thereby determining the image quality.

The preset image quality category may be represented by using a corresponding category feature, and different preset image quality categories are represented by using different category features. For example, image features extracted from a plurality of clear images are used to represent that the image quality is a quality category of a clear image, image features extracted from a plurality of blurry images are used to represent that the image quality is a quality category of a blurry image, and image features extracted from intermediate images between the clear images and the blurry images are used to represent that the image quality is an intermediate quality category. The clear images, the blurry images, and the intermediate images may be pre-marked. The category feature is configured for representing a semantic feature of an image represented by a corresponding preset image quality category. In other words, if the preset image quality category is the clear image category, a corresponding category feature represents a clear image, and if the preset image quality category is the blurry image category, a corresponding category feature represents a blurry image. Images represented by the preset image quality category may be pre-marked or may be obtained based on image quality evaluation. The image quality evaluation may be determined based on the image distortion degree. Different quality categories may correspond to preset image distortion degree ranges. The preset reference element image is an image that a preset reference element is in, and an image quality category of the preset reference element image is the same as a corresponding preset image quality category. Each preset image quality category has a plurality of corresponding preset reference element images, and a correspondence between the preset image quality category and the plurality of preset reference element images may be preset. A plurality may be at least two. The reference element is an element of the same type as the target element. For example, in a road image, the reference element and the target element may both be physical point image regions on a road, and in a face image, the reference element and the target element may both be face regions in the face image. The reference element image feature is a feature obtained through semantic information extraction performed on the reference element image.

The server extracts the semantic information of the target element region, to obtain the current region feature corresponding to the target element region. The extraction may be performed by using a pre-trained neural network model for extracting semantic information. The neural network may be a feedforward neural network, a recurrent neural network, or the like. In some embodiments, the server may extract a color feature, a texture feature, a shape feature, a spatial relationship feature, and the like corresponding to the target element region as the current region feature corresponding to the target element region. The target element region in the input image is obtained by performing recognition by using the input image as a whole, and then the current region feature of the target element region is extracted after the target element region is extracted, ensuring accuracy of the extracted current region feature.

The server obtains the category feature corresponding to each preset image quality category from a database. The preset image quality category includes, but is not limited to, the clear image category and the blurry image category. The server obtains the clear category feature corresponding to the clear image category and the blurry category feature corresponding to the blurry image category from the database. The clear category feature corresponding to the clear image category may be obtained in the following manner. The server obtains the plurality of preset reference element images corresponding to the clear image category in advance, for example, quality categories of the plurality of preset reference element images are all of the clear image category. The server respectively performs semantic information extraction on the plurality of preset reference element images, to obtain a reference element image feature corresponding to each preset reference element image. Finally, the server fuses the reference element image feature corresponding to each preset reference element image, to obtain the clear category feature corresponding to the clear image category. The category feature corresponding to the blurry image category may be obtained in the following manner. The server obtains a plurality of preset reference element images corresponding to the blurry image category in advance, for example, quality categories of the plurality of preset reference element images are all of the blurry image category, then performs semantic information extraction on each preset reference element image, to obtain a reference element image feature corresponding to each preset reference element image, and finally the server fuses the reference element image feature corresponding to each preset reference element image, to obtain the blurry category feature corresponding to the blurry category. In some embodiments, the preset image quality category may include an intermediate image category, and the server obtains a category feature corresponding to the intermediate image category from the database at the same time. The category feature corresponding to the intermediate image category is obtained in the following manner. The server obtains the plurality of preset reference element images corresponding to the intermediate image category in advance, quality categories of the plurality of preset reference element images are all of the intermediate image category, then performs semantic information extraction on each preset reference element image, to obtain a reference element image feature corresponding to each preset reference element image, and the server finally fuses the reference element image feature corresponding to each preset reference element image, to obtain the intermediate category feature corresponding to the intermediate image category. The intermediate image category is a category between the clear image category and the blurry image category, and is configured for representing that the clear degree of the image is between clear and blurry. In some embodiments, the server may fuse features of preset reference element images of all similar quality categories, to obtain a category feature corresponding to all the similar quality categories. For example, quality categories that may be preset include a first clear category and a second clear category, and a difference between clear degrees of images represented by the first clear category and the second clear category is not more than 2%, and the first clear category and the second clear category may be similar quality categories. All preset reference element images corresponding to the first clear category and the second clear category are then obtained, semantic features of all the preset reference element images are extracted, and the semantic features of all the preset reference element images are fused, to obtain a category feature corresponding to both the first clear category and the second clear category.

210: Compare the current region feature with each category feature respectively, to obtain a matching degree between the current region feature and the category feature, and determine a target category feature corresponding to the current region feature from the category features based on the matching degrees.

The matching degree is configured for representing a similarity between the current region feature and the category feature. A higher similarity indicates that the current region feature is more consistent with the category feature, and indicates that the image quality category of the target element image is more consistent with the image quality category corresponding to the reference element image. The target category feature is a category feature with a highest matching degree with the current region feature in the plurality of category features.

The server may respectively compare the current region feature with each category feature. In other words, the server may calculate, by using a similarity algorithm, a matching degree between the current region feature and the category feature corresponding to each preset image quality category. The similarity algorithm may be a cosine similarity algorithm, a distance similarity algorithm, or the like. The server then compares all matching degrees, and selects a category feature corresponding to the largest matching degree from the matching degrees as the target category feature corresponding to the current region feature.

212: Output a preset image quality category corresponding to the target category feature as a target region quality category of the target element region, and determine an image quality category of the input image based on the target region quality category.

The target region quality category is an image quality category to which the target element region belongs, and is configured for representing image quality of the target element region in the input image. The image quality category is a quality category of the input image, and is configured for representing image quality of the whole input image.

The server may determine the preset image quality category corresponding to the target category feature as the target region quality category of the target element region. In some embodiments, the server may obtain at least two target category features from category features corresponding to the preset image quality categories based on the matching degrees. For example, the server may sort all calculated matching degrees in descending order, and then select corresponding category features in sequence order, to obtain the at least two target category features. Quality categories corresponding to the at least two target category features are obtained, and when preset image quality categories corresponding to the at least two target category features are consistent, the preset image quality category is determined as the target region quality category of the target element region. When quality categories corresponding to the at least two target category features have an inconsistent preset image quality category, the server may determine a quality category representing higher image quality as the target region quality category of the target element region, or the server may determine a quality category representing lower image quality as the target region quality category of the target element region.

The target region quality category of the target element region is determined as the image quality category corresponding to the input image. When the input image includes one target element region, the server may directly determine the target region quality category of the target element region as the image quality category corresponding to the input image. When the input image includes at least two target element regions, the server may determine the image quality category corresponding to the input image based on the target region quality category of each target element region. The server may determine a target region quality category representing the highest image quality as the image quality category corresponding to the input image. The server may determine a target region quality category representing the lowest image quality as the image quality category corresponding to the input image. The server may collect a target region quality category of each target element region, and determine the obtained same target region quality category corresponding to a largest quantity as the image quality category corresponding to the input image. The server may collect a region quality category of each target element region, and determine the obtained same target region quality category corresponding to a lowest quantity as the image quality category corresponding to the input image.

In some embodiments, the input image may be directly the target element image. The server may directly obtain a target element image on which image quality detection is to be performed, then extract a current image feature corresponding to the target element image, calculate a matching degree between the current image feature and each category feature, and directly determine an image quality category corresponding to the target element image based on the matching degree, so that target element detection may not be performed, and image quality detection efficiency is improved.

According to the image quality detection method and apparatus, the computer device, the storage medium, and the computer program product, a target element in an input image is recognized, to obtain a target element region in which the target element is located in the input image; a current region feature corresponding to the target element region is extracted; category features respectively corresponding to a plurality of preset image quality categories are obtained, where the category feature is obtained by respectively performing feature extraction on a plurality of preset reference element images of a preset image quality category to obtain a plurality of corresponding reference element image features and fusing the plurality of reference element image features; the current region feature is compared with each category feature respectively, to obtain a matching degree between the current region feature and the category feature, and a target category feature corresponding to the current region feature is determined from the category features based on the matching degrees; and a preset image quality category corresponding to the target category feature is output as a target region quality category of the target element region, and the image quality category of the input image is determined based on the target region quality category. In other words, the quality category of the target element region in the input image is determined by matching the category feature representing the preset image quality category with the image feature of the target element region in the input image, and then the image quality category of the input image is determined based on the region quality category of the target element region, thereby avoiding determining an image quality category of another region other than the target element region in the input image as the image quality category of the input image, to improve accuracy of the obtained image quality category.

In some embodiments, before operation 202, for example, before obtaining the input image and recognizing the target element in the input image, to obtain the target element region of the target element in the input image, the method may further include the following operations:
obtaining a plurality of preset reference element images of a preset image quality category; respectively performing feature extraction on the plurality of preset reference element images, to obtain a plurality of corresponding reference element image features; and fusing the plurality of reference element image features, to obtain a category feature corresponding to the preset image quality category.

The preset image quality category is a preset quality category, different quality categories are configured for reflecting different image quality, and image quality of the same quality category is the same or similar. The quality category may be a quality level, and each quality level may correspond to one quality category. A higher quality level indicates better image quality, for example, a higher clear image degree. On the contrary, a lower quality level indicates lower image quality, for example, a lower clear image degree, and an image is blurrier.

The server may obtain the plurality of preset reference element images of the preset image quality category from the database. In a same application scenario, a same quality category has different images corresponding to a reference element. The server may obtain the plurality of preset reference element images of the preset image quality category in the application scenario from the database. The server may obtain the plurality of preset reference element images of the preset image quality category in the application scenario uploaded by the terminal. The server may obtain the plurality of preset reference element images of the preset image quality category sent by the serving party providing the business service. The server may obtain the plurality of preset reference element images of a quality category from a serving party providing a data service.

The server may extract a feature of each preset reference element image by using a trained neural network with semantic information extraction, to obtain a preset reference element image feature of each preset reference element image. The neural network is an algorithm data model that imitates a behavior feature of an animal neural network and performs distributed parallel information processing. The neural network may process information by adjusting mutual connection relationships between a large number of internal nodes. The server may extract a color feature, a texture feature, a shape feature, and a spatial relationship feature of each preset reference element image, and then splice the color feature, the texture feature, the shape feature, and the spatial relationship feature to obtain the reference element image features. The server fuses the reference element image features. The fusion may be directly splicing or combining all the reference element image features. The fusion may be performing a feature vector operation on the reference element image features. For example, a feature vector sum operation or a feature vector product operation may be performed, to obtain the category feature corresponding to the preset image quality category.

In some embodiments, at least two preset image quality categories may be included. The server then obtains a plurality of reference element images respectively corresponding to the at least two preset image quality categories, respectively performs feature extraction on the plurality of reference element images corresponding to each preset image quality category, to obtain a plurality of reference element image features corresponding to each preset image quality category, and fuses all the reference element image features corresponding to each preset image quality category, to obtain a category feature of each quality category.

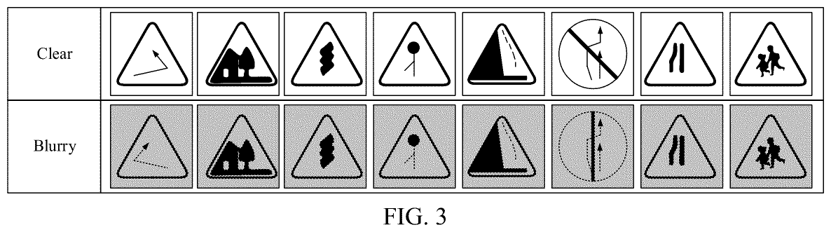

In some embodiments, FIG. 3 is a schematic diagram of images of different preset image quality categories. In other words, the server can obtain various sign images on a road in a map application scenario, including sign images corresponding to the blurry image category and sign images corresponding to the clear image category. The server extracts features of blurry sign images corresponding to the blurry image category, and fuses the features of the blurry sign images, to obtain the category feature of the blurry image category. The server then extracts features of clear sign images corresponding to the clear image category, and fuses the features of the clear sign images, to obtain the category feature of the clear image category.

In some embodiments, the plurality of reference element images corresponding to the preset image quality category are obtained; the feature extraction is performed on each reference element image, to obtain the plurality of corresponding reference element image features; and the plurality of reference element region features are fused, to obtain the category feature corresponding to the preset image quality category. In other words, the features of the plurality of reference element images of the same preset quality category are fused, to obtain the category feature corresponding to the preset image quality category, so that the obtained category feature is more accurate.

In some embodiments, that the plurality of reference element image features are fused, to obtain the category feature corresponding to the preset image quality category includes the following operations:
splicing the reference element region features, to obtain a spliced feature; and performing a convolution operation based on the spliced feature, to obtain the category feature corresponding to the preset image quality category.

The spliced feature is a feature obtained through splicing the reference element region features head to tail.

The server may splice the reference element region features head to tail, to obtain the spliced feature. The head-to-tail splicing may be sequentially splicing the reference element region features head to tail in a preset splicing sequence. The splicing sequence may be determined based on a sequence in which the server obtains the reference element regions. The splicing sequence may be determined based on a sequence in which the server finds the reference element regions. The server then performs a convolution operation on the spliced feature by using a convolutional parameter. The convolutional parameter is configured for feature fusion, and is obtained through training in advance and is preset. Fusion and dimension reduction are performed on the spliced feature through the convolution operation, to obtain the category feature corresponding to the preset image quality category. In some embodiments, the server may superimpose the reference element region features, to obtain a superimposed feature. Feature vectors are superimposed, to obtain a feature map, the feature map is used as the superimposed feature, and a convolution operation is performed on the superimposed feature by using a convolution parameter, to obtain the category feature corresponding to the preset image quality category.

In some embodiments, the reference element region features are spliced to obtain the spliced feature, and then the convolution operation is performed based on the spliced feature, to obtain the reference region feature corresponding to the quality category. The convolution operation is performed by using the convolutional parameter to perform feature fusion, so that more detailed and more accurate semantic information can be extracted, and the obtained category feature can be more accurate.

In some embodiments, the image quality detection method further includes the following operations:
obtaining a trained image feature extraction model, and respectively inputting the plurality of reference element images to the image feature extraction model; respectively performing feature extraction on the plurality of reference element images by using a feature extraction network in the image feature extraction model, to obtain a plurality of corresponding reference element image features; and fusing the reference element region features by using a feature fusion network in the reference feature extraction model, to obtain the reference region feature corresponding to the preset image quality category.

The image feature extraction model is a neural network model configured to extract the category feature corresponding to the preset image quality category. The image feature extraction model is obtained through pre-training, may be trained by using training data, or may be obtained from an image classification model or an image recognition model that includes an image feature extraction part. The feature extraction network is a neural network configured for image feature extraction, and may be a convolutional neural network, a recurrent neural network, or the like. The feature fusion network is a neural network configured for feature fusion, and may be a convolutional neural network, a recurrent neural network, or the like.

The server obtains the pre-trained image feature extraction model. The image feature extraction model may be obtained by training a neural network by using a training image and an image tag feature corresponding to the training image. The image tag feature may be pre-marked. The image feature extraction model may be obtained from a trained image recognition model that may perform image feature extraction and fusion. In other words, a part in the image recognition model for performing image feature extraction and fusion is used as the image feature extraction model. The server deploys the image feature extraction model. When the plurality of reference element images are obtained, the deployed image feature extraction model may be invoked to perform feature extraction. The server uses the plurality of reference element images as an input of the image feature extraction model; and a feature extraction network in the image feature extraction model receives each reference element image, and extracts a reference element image feature corresponding to each reference element image by using a trained feature extraction parameter. All the reference element image features are input to a feature fusion network. The feature fusion network splices all the reference element image features, to obtain the spliced feature, and then performs a neural network operation by using the spliced feature and a network parameter, to obtain output category features of the preset image quality categories corresponding to the plurality of reference element images.

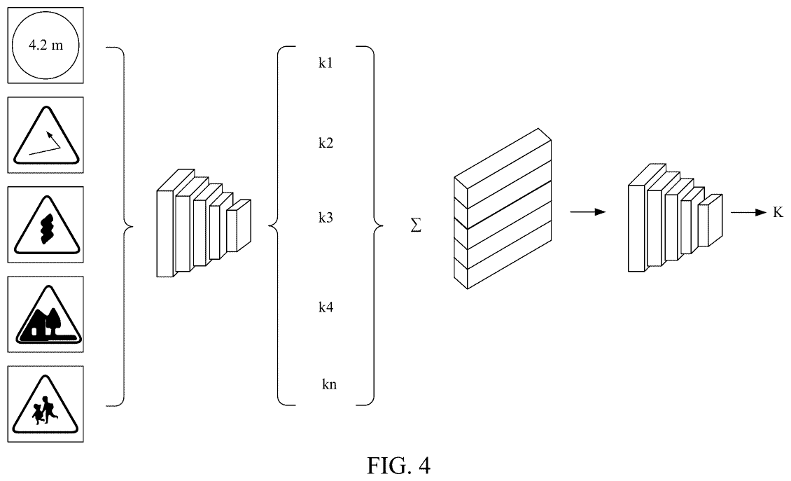

In some embodiments, FIG. 4 is a schematic architectural diagram of an image feature extraction model. The server obtains a plurality of blurry road sign images, and inputs the plurality of blurry road sign images to the convolutional neural network for feature extraction, to obtain a feature vector of each road sign image. The feature vectors include k1, k2, k3, k4, . . . , and kn, where k1 represents a feature vector of the first road sign image, and by analogy, kn represents a feature vector of the n^{th} road sign image. The feature vectors of the road sign images are then superimposed, to obtain a superimposed feature map. A convolution operation is performed on the superimposed feature map by using the convolutional neural network, to obtain an output reference region feature K corresponding to the blurry image category.

In some embodiments, the feature extraction is performed on the reference element regions by using the feature extraction network in the reference feature extraction model, to obtain the reference element region features, and the reference element region features are fused by using the feature fusion network in the reference feature extraction model, to obtain the reference region feature corresponding to the quality category. The trained image feature extraction model is directly used to obtain the category feature corresponding to the quality category, thereby improving efficiency and accuracy of the obtained category feature.

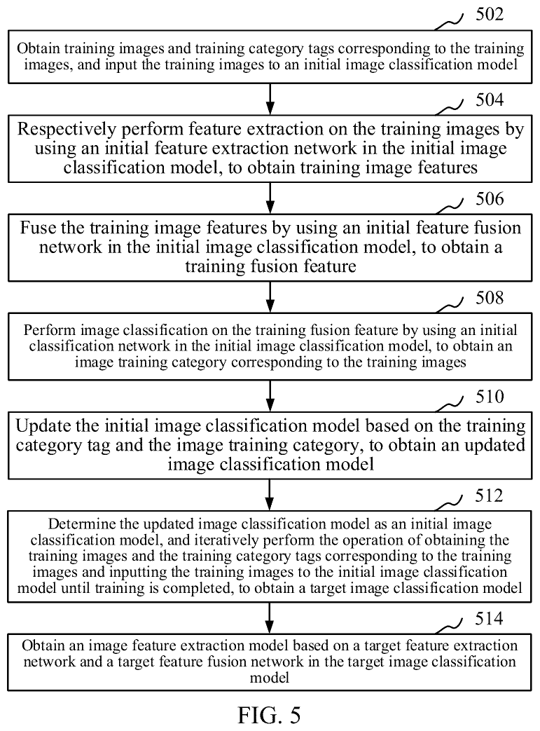

In some embodiments, as shown in FIG. 5, training the image feature extraction model include the following operations.

502: Obtain training images and training category tags corresponding to the training images, and input the training images to an initial image classification model.

The training image is an image used during training of the reference feature extraction model. The training category tag is a tag of a category corresponding to training images, and the training category tag is preset. The category corresponding to the training images may be a category obtained by classifying objects in the training images, and the object in the training image may be a real object such as a person, an animal, or a plant. The object in the training image may be a virtual object, for example, a virtual person, a virtual animal, or a virtual plant. The training images correspond to a same training category tag. Categories corresponding to the training images may be the same. For example, the objects in the training images are belong to a person category. The initial image classification model is an image classification model with an initialized model parameter. The image classification model is a neural network model configured for classifying an image. Classifying the image may be classifying an object in the image, classifying and recognizing quality of the image, classifying a scenario of the image, or the like.

The server may obtain training images and training category tags corresponding to the training images from the database, may obtain training images and training category tags corresponding to the training images from the serving party providing the data service, may obtain training images and training category tags corresponding to the training images uploaded by the terminal, or may obtain training images and training category tags corresponding to the training images from serving party providing the business service. The server establishes the initial image classification model by using the neural network. The server establishes a neural network architecture configured for image classification, and then initializes a network parameter in the neural network. For example, initialization may be zero initialization, random initialization, Gaussian distribution initialization, or the like, to obtain the initial image classification model.

504: Respectively perform feature extraction on the training images by using an initial feature extraction network in the initial image classification model, to obtain training image features.

The initial feature extraction network is a feature extraction network with an initialized network parameter. The feature extraction network is configured for image feature extraction. The feature extraction network may be a convolutional neural network, a recurrent neural network, or the like. The training image feature is a feature corresponding to the training image extracted by using the initialized network parameter in the initial feature extraction network during training.

The server respectively performs feature extraction on the training images by using the initial feature extraction network in the initial image classification model, to obtain the training image features. Weighting calculation may be performed on the training image by using the initialized network parameter in the initial feature extraction network, to obtain an output training image feature. The training image feature may be a feature vector, a feature map, or a feature matrix. The initial feature extraction network sequentially performs feature extraction on each training image, and when the feature extraction on all training images is completed, the training image feature corresponding to each training image is obtained.

506: Fuse the training image features by using an initial feature fusion network in the initial image classification model, to obtain a training fusion feature.

508: Perform image classification on the training fusion feature by using an initial classification network in the initial image classification model, to obtain an image training category corresponding to the training images.

The initial feature fusion network is a feature fusion network with an initialized network parameter, the feature fusion network is a network configured for fusing features, and the fused feature extracted by using the feature fusion network includes common image semantic information. The training fusion feature is a fusion feature extracted during training. The initial classification network is a classification network with an initialized network parameter. The classification network is a network for classification and recognition. Categories in the classification network are preset. The classification network recognizes a probability of a category, and determines a final category based on the probability of the category. The image training category is a category corresponding to training images obtained through recognition during training. The category may be a category of an object in the training images, may be a category of a scenario of the training images, or the like.

The server fuses the training image features by using the initial feature fusion network in the initial image classification model, to obtain the training fusion feature. In other words, the server performs weighting calculation on the training image features by using the network parameter in the initial feature fusion network, to obtain the training fusion feature, and then performs classification calculation by using the training fusion feature and the network parameter in the initial classification network, to obtain an output image training category. In other words, the server may perform weighting calculation on the training fusion feature by using the network parameter of the initial classification network, and then perform normalization calculation, to obtain the output image training category.

510: Update the initial image classification model based on the training category tag and the image training category, to obtain an updated image classification model.

512: Determine the updated image classification model as an initial image classification model, and iteratively perform the operation of obtaining the training images and the training category tags corresponding to the training images and inputting the training images to the initial image classification model until training is completed, to obtain a target image classification model.

The updated image classification model is an image classification model with an updated network parameter. The target image classification model is an image classification model that reaches a training complete condition. The training complete condition may be that training reaches a maximum quantity of iterations, a network parameter obtained through training no longer changes, a loss of training reaches a loss threshold, or the like.

The server calculates loss information of model training by using the training category tag and the image training category, and may calculate a difference between the training category tag and the image training category by using a classification loss function, to obtain the loss information of model training. The model parameter in the initial image classification model is inversely updated based on the loss information by using a gradient descent algorithm, to obtain the updated image classification model. The server then determines the updated image classification model as the initial image classification model, and iteratively performs the operation of obtaining the training images and the training category tags corresponding to the training images and inputting the training images to the initial image classification model until training is completed, and determines the trained initial image classification model as a target image classification model finally obtained through training.

514: Obtain the image feature extraction model based on a target feature extraction network and a target feature fusion network in the target image classification model.

The target feature extraction network is a trained neural network configured for feature extraction, and the target feature fusion network is a trained neural network configured for feature fusion.

The server segments the target feature extraction network and the target feature fusion network from the trained target image classification model, and determines the target feature extraction network and the target feature fusion network as the image feature extraction model.

In some embodiments, training images and training category tags corresponding to the training images are obtained, and the training images are input to an initial image classification model for training. When training is completed, a target feature extraction network and a target feature fusion network in a target image classification model obtained through training are used as an image feature extraction model. In other words, the target image classification model obtained through training by using the training category tag that is conveniently obtained, the image feature extraction model is obtained from the target image classification model, and a tag for training the image feature extraction model may not be marked, thereby improving efficiency and accuracy of the obtained reference feature extraction model.

In some embodiments, in operation 204, recognizing the target element in the input image, to obtain the target element region in which the target element is located in the input image may include:

extracting an image convolution feature of the input image, and performing noise filtering based on the image convolution feature, to obtain a filtered feature; and performing non-linear mapping on the filtered feature, to obtain a mapped feature, and performing target element region extraction based on the mapped feature, to obtain the target element region in which the target element is located in the input image.

The image convolution feature is an image feature obtained through the convolutional calculation. The filtered feature is an image feature obtained after noise information in the feature is filtered. The mapped feature is an image feature obtained through non-linear mapping.

The server performs convolutional calculation on a pixel value corresponding to the input image based on a pretrained convolutional parameter, to extract the image convolution feature. Normalization calculation is performed on the image convolution feature by using the normalization algorithm. In other words, the noise information in the feature is filtered, to obtain the filtered feature. The normalization algorithm may be a min-max normalization algorithm, an average normalization algorithm, or the like. Non-linear mapping is performed on the filtered feature by using a non-linear mapping function, to obtain the mapped feature. The non-linear mapping function may be an activation function, and the activation function may be a Relu function. Finally, target element region extraction is performed by using the mapped feature, to obtain the target element region of the target element in the input image. Each target element candidate region and a corresponding confidence may be determined by using the mapped feature, and then a target element candidate region corresponding to a largest confidence is selected from the target element candidate regions of the target element in the input image based on the confidence, to obtain the target element region of the target element in the input image.

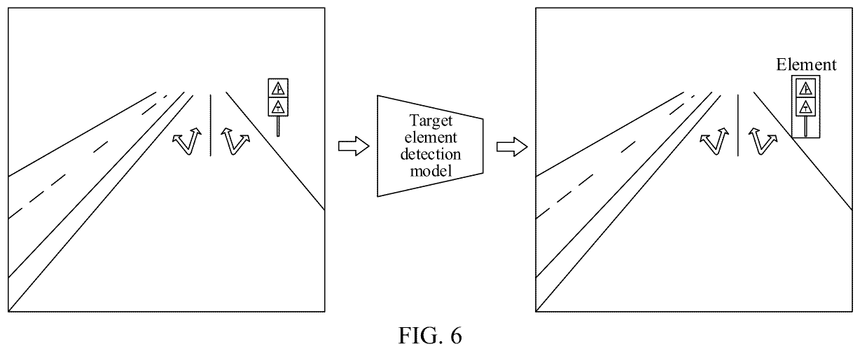

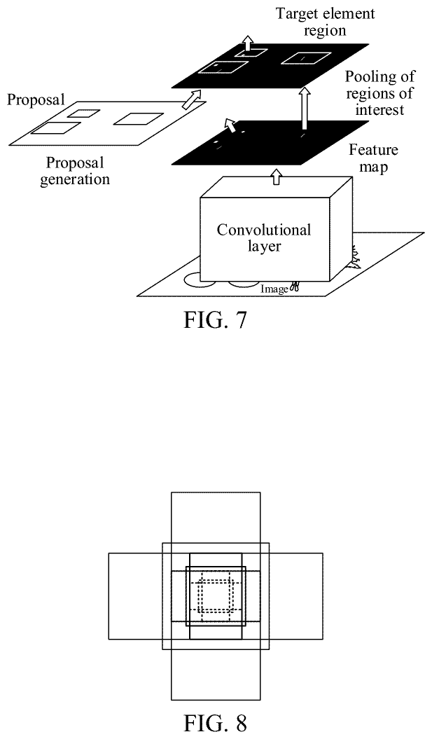

In some embodiments, the target element in the input image may be recognized by using a target element detection model, to obtain the target element region in which the target element is located in the input image. FIG. 6 is a schematic diagram of an overall framework of target element recognition. The input image, for example, an image on the left of FIG. 6, is obtained. The input image is input to the target element detection model. The target element detection model may be established by using the convolutional neural network. FIG. 7 is a schematic diagram of a model structure of a target element detection model. Feature extraction is performed on the input image by using a feature extraction part. The feature extraction part includes a convolution layer, a batch normalization layer, and an activation layer (Relu). The convolution layer is configured to extract a feature such as an edge texture. The batch normalization layer is configured to normalize, based on a normal distribution, the feature extracted by the convolution layer, to filter noise information in the feature, so that convergence of the model is accelerated. The activation layer is responsible for performing non-linear mapping on feature extracted by the convolution layer, to strengthen a model generalization capability. The feature map corresponding to the input image is extracted by using the feature extraction portion, and then the target element detection model generates a proposal and a confidence level according to the extracted feature map. FIG. 8 is a schematic diagram of proposal generation. Extracted image features are used, nine proposals are selected with each feature point as a central point, each of three ratios {1:1, 2:1, 1:2} as an aspect ratio, and one, two, and three feature points respectively as a scale, and used as target element detection proposals. The target element region is finally determined from target element detection proposals based on corresponding confidences. A boxed part in an output image in FIG. 6 is the determined target element region, and the target element region is a road sign region in the input image.

In some embodiments, the image convolution feature of the input image is extracted, noise filtering is performed, and then non-linear mapping is performed, to obtain the mapped feature. Finally, region extraction is performed by using the mapped feature, to obtain the target element region in which the target element is located in the input image. In other words, noise in the image feature is filtered, and non-linear mapping is performed to perform target element region extraction, thereby improving accuracy of the obtained target element region.

In some embodiments, in operation 210, comparing the current region feature with each category feature respectively, to obtain the matching degree between the current region feature and the category feature, and determining the target category feature corresponding to the current region feature from the category features based on the matching degrees may include:
calculating a similarity between the current region feature and each category feature, to obtain a matching degree between the current region feature and the category feature; and
determining a target matching degree from the matching degrees between the current region feature and the category features, and determining a category feature corresponding to the target matching degree as the target category feature corresponding to the current region feature.

The target matching degree is a matching degree between the current region feature and the most similar category feature, for example, may be the largest matching degree in all matching degrees.

The server may calculate the similarity between the current region feature and the category feature corresponding to each preset image quality category by using a similarity algorithm. For example, the server calculates a similarity between the current region feature and a category feature of the blurry image category, calculates a similarity between the current region feature and a category feature of the clear image category, or may calculate a similarity between the current region feature and a category feature corresponding to another preset image quality category, and uses the similarity as a matching degree between the current region feature and the category feature, to obtain a matching degree between the current region feature and each category feature. The matching degrees are compared, the largest matching degree is selected from the matching degrees as the target matching degree, and the category feature corresponding to the target matching degree is used as the target category feature corresponding to the current region feature. The server may calculate the similarity by using the similarity algorithm. The similarity algorithm may be a distance similarity algorithm, for example, a Euclidean distance similarity algorithm, or a cosine similarity algorithm.

In some embodiments, the similarity between the current region feature and the category feature may be calculated by using Formula (1) below.

$$c = F ( {k}_{p}^{2} , {K}^{{Z}_{i}} ) \qquad Formula ( 1 )$$

c is the calculated similarity, F is the similarity algorithm, and ky is the current region feature. K^{Z}^{ᵢ} is a category feature corresponding to the i^{th} preset image quality category. In other words, the similarity can be calculated by using a spatial norm similarity algorithm, to obtain the similarity. A similarity closer to 1 indicates more similarity, and a similarity closer to 0 indicates more difference. The similarity may be calculated by using Formula (2) below. In other words, a quadratic sum of distance differences corresponding to feature bits is calculated to obtain the similarity.

$$c = {\sum }_{j = 1}^{Z} ( {( {k}_{p}^{j} - {K}_{i}^{j} )}^{2} ) \qquad Formula ( 2 )$$

Kₚ^{j} is the j^{th} feature bit in the current region feature. Kᵢ^{j} is the j^{th} feature bit in the category feature. Z is a number of bits of a feature, and is a positive integer. A number of bits of the current region feature may be the same as a number of bits of the category feature.

In some embodiments, the similarities between the current region feature and the reference region features corresponding to the quality categories are calculated, to obtain the matching degrees, the target matching degree is determined from the matching degrees, and the reference region feature corresponding to the target matching degree is used as the target reference region feature corresponding to the current region feature. In other words, the category feature most matching the current region feature is used as the target reference region feature corresponding to the current region feature, thereby improving the accuracy of the obtained target reference region feature.

In some embodiments, the quality category includes the clear image category and the blurry image category.

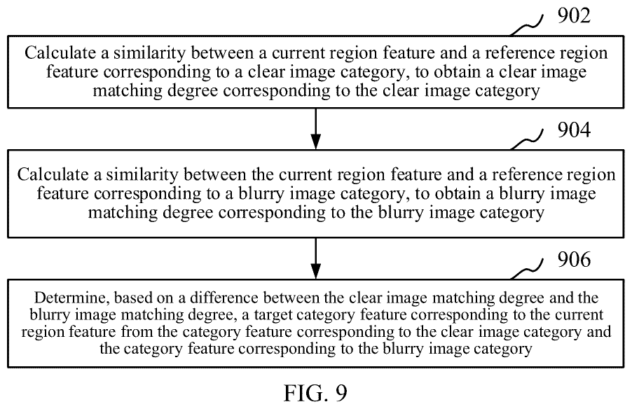

As shown in FIG. 9, in operation 210, comparing the current region feature with each category feature respectively, to obtain the matching degree between the current region feature and the category feature, and determining the target category feature corresponding to the current region feature from the category features based on the matching degrees may include the following operations.

902: Calculate a similarity between the current region feature and a reference region feature corresponding to the clear image category, to obtain a clear image matching degree corresponding to the clear image category.

904: Calculate a similarity between the current region feature and a reference region feature corresponding to the blurry image category, to obtain a blurry image matching degree corresponding to the blurry image category.

The clear image category is an image quality category configured for representing a clear image. The clear image may be an image with a clear image degree greater than a preset threshold, or the clear image may be an image that is manually set. The blurry image category is an image quality category configured for representing a blurry image. A clear image degree of the blurry image is less than a preset threshold, or the blurry image may be an image that is manually set. The image may include a blurry image and a clear image. The blurry image indicates that the image has poor quality and may be filtered. The clear image indicates that the image has good quality, and can be used subsequently. The clear image matching degree is configured for representing a probability that the target element region is of the clear image category. A higher clear image matching degree indicates a higher probability that the target element region is of the clear image category. The blurry image matching degree is configured for representing a probability that the target element region is of the blurry image category. A higher blurry image matching degree indicates a higher probability that the target element region is of the blurry image category.

When the plurality of preset image quality categories include the clear image category and the blurry image category, when calculating the matching degree, the server may calculate the similarity between the current region feature and the category feature corresponding to the clear image category by using the distance similarity algorithm, to obtain the clear image matching degree; and then calculate the similarity between the current region feature and the category feature corresponding to the blurry image category by using the distance similarity algorithm, to obtain the blurry image matching degree. The distance similarity algorithm may be a Euclidean distance algorithm, a cosine distance algorithm, or the like.

906: Determine, based on a difference between the clear image matching degree and the blurry image matching degree, the target category feature corresponding to the current region feature from the category feature corresponding to the clear image category and the category feature corresponding to the blurry image category.

The server calculates the difference between the clear image matching degree and the blurry image matching degree. For example, the difference between the matching degrees may be obtained by subtracting the blurry image matching degree from the clear image matching degree. The difference is configured for representing the difference between the detected clear image category and blurry image category. A category feature corresponding to the current region feature is determined from the reference region feature corresponding to the clear image category and the reference region feature corresponding to the blurry image category based on a value of the difference. When the difference is a positive value, the clear image matching degree is greater than the blurry image matching degree. The category feature corresponding to the clear image matching degree can be used as the target category feature corresponding to the current region feature. When the difference is a negative value, the blurry image matching degree is greater than the clear image matching degree. The category feature corresponding to the blurry image matching degree can be used as the target category feature corresponding to the current region feature.

In some embodiments, the clear image matching degree and the blurry image matching degree are obtained through calculation, then the difference between the clear image matching degree and the blurry image matching degree is calculated, and the target category feature corresponding to the current region feature is determined from the category feature corresponding to the clear image category and the category feature corresponding to the blurry image category based on the difference. The category feature corresponding to a relatively large matching degree is selected as the target category feature corresponding to the current region feature by comparing the difference between the clear image matching degree and the blurry image matching degree, thereby improving the accuracy of the obtained target reference region feature.

In some embodiments, in operation 906 determining, based on the difference between the clear image matching degree and the blurry image matching degree, the target category feature corresponding to the current region feature from the category feature corresponding to the clear image category and the category feature corresponding to the blurry image category may include:
calculating the difference between the clear image matching degree and the blurry image matching degree, and comparing the clear image matching degree with the blurry image matching degree when the difference exceeds a preset difference threshold; when the clear image matching degree is greater than the blurry image matching degree, determining the category feature corresponding to the clear image category as the target category feature corresponding to the current region feature; and when the blurry image matching degree is greater than the clear image matching degree, determining the category feature corresponding to the blurry image category as the target category feature corresponding to the current region feature.

The preset difference threshold is a preset threshold of a difference between the clear image matching degree and the blurry image matching degree.

The server calculates the difference between the clear image matching degree and the blurry image matching degree. In other words, the server subtracts the blurry image matching degree from the clear image matching degree to obtain the difference, and then compares an absolute value of the difference with the preset difference threshold. When the absolute value of the difference exceeds the preset difference threshold, the difference between the clear image matching degree and the blurry image matching degree is relatively large, and the quality category can be clearly determined, where exceeding means being greater than. The server compares the clear image matching degree with the blurry image matching degree. When the clear image matching degree is greater than the blurry image matching degree, the current region feature is more similar to the category feature corresponding to the clear image category, and the server determines the category feature corresponding to the clear image category as the target category feature corresponding to the current region feature. When the blurry image matching degree is greater than the clear image matching degree, the current region feature is more similar to the category feature corresponding to the image template category, and the server determines the category feature corresponding to the blurry image category as the target category feature corresponding to the current region feature. For example, the clear image matching degree is 0.9, the blurry image matching degree is 0.2, and the difference is 0.7. The difference of 0.7 exceeds the difference threshold 0.5. The clear image matching degree of 0.9 is greater than the blurry image matching degree of 0.2, so that the current region feature is more similar to the category feature corresponding to the clear image category, for example, the preset image quality category of the target element region is the clear image category.

In some embodiments, when the difference does not exceed the preset difference threshold, a preset undetermined category is used as the region quality category of the target element region.

The undetermined category is a preset image quality category for which a difference does not exceed the difference threshold. The undetermined category is configured for representing that the quality category of the image belongs to a case that the quality category of the image cannot be determined. In other words, whether the quality category of the target element region is the clear image category or the blurry image category cannot be determined, where not exceeding means being less than or equal to.

When determining that the absolute value of the difference does not exceed the difference threshold, the server may directly determine the preset undetermined category as the target region quality category of the target element region. Detection may be performed on a target element region of the preset undetermined category again, or the input image having the target element region may be directly filtered. In some embodiments, when the similarity between the target region quality category of the target element region and the clear image category is high, and the similarity between the target region quality category of the target element region and the blurry image category is low, it is determined that the target region quality category of the target element region is the clear image category. When the similarity between the target region quality category of the target element region and the blurry image category is low, and the similarity between the target region quality category of the target element region and the blurry image category is high, it is determined that the target region quality category of the target element region is the blurry image category. When similarities between the target region quality category of the target element region and the clear image category and between the target region quality category and the blurry image category are consistent, for example, the similarities are both high or low, the image quality category of the target element region cannot be determined. For example, the clear image matching degree is 0.9, the blurry image matching degree is 0.8, and the difference is 0.1. The difference of 0.1 does not exceed the preset difference threshold of 0.5. The quality category of the target element region cannot be determined. In other words, the quality category of the target element region is neither the blurry image category nor the clear image category. A target element region belonging to the undetermined category may be manually determined, or image quality detection may be performed again.

In some embodiments, the difference between the clear image matching degree and the blurry image matching degree is calculated, and the difference is compared with the preset difference threshold. When the difference exceeds the preset difference threshold, the clear image matching degree is compared with the blurry image matching degree to determine the target reference region feature corresponding to the current region feature. When the difference does not exceed the preset difference threshold, the preset undetermined category is used as the region quality category of the target element region, so that the input image whose image quality cannot be determined can be detected, thereby improving the accuracy of the image quality detection.

In some embodiments, at least two target element regions are included.

In operation 212, determining the image quality category of the input image based on the target region quality category, may include the following operation:
respectively calculating region ratios of the at least two target element regions to the input image, screening the at least two target element regions based on the region ratios to obtain a current target element region, and determining a target region quality category of the current target element region as the image quality category of the input image.

The region ratio is a ratio of an area of the target element region to an area of the whole input image.

The server obtains target region quality categories of all target element regions in the input image. When the target region quality categories of all target element regions are inconsistent, the server calculates a region area of the target element region and an image area of the input image, and then calculates the ratio of the region area to the image area, to obtain the region ratio corresponding to the target element region. The server traverses all the target element regions in the input image, to obtain a region ratio of each target element region. The at least two target element regions are screened based on the region ratios, to obtain the current target element region. A target element region with a largest region ratio may be selected, to obtain the current target element region, and then a target region quality category of the current target element region is determined as the image quality category of the input image. When target region quality categories of all target element regions are consistent, the target region quality category is directly determined as the image quality category of the input image.

In some embodiments, when the input image includes at least two target element regions, respective region ratios of the at least two target element regions to the input image are calculated, and the target region quality category of the target element region with the largest region ratio is determined as the image quality category corresponding to the input image, so that accuracy of the image quality category corresponding to the input image can be improved.

In some embodiments, the image quality detection method further includes:

inputting the target element region and the category features respectively corresponding to the plurality of preset image quality categories to an image quality detection model; and extracting a current region feature corresponding to the target element region by using a feature extraction network in the image quality detection model, respectively comparing the current region feature with each category feature, to obtain the matching degree between the current region feature and the category feature, determining the target category feature corresponding to the current region feature from the category features based on the matching degrees, and determining the preset image quality category corresponding to the target category feature as the target region quality category of the target element region for output.

The image quality detection model is a neural network model for detecting image quality of the target element region, and the neural network model is obtained by training through a neural network using a historical target element region and a corresponding image quality category tag. The feature extraction network is a neural network configured for image feature extraction.

The server obtains the historical target element region and the corresponding image quality category tag in advance to train the neural network with a set architecture and an initialized parameter, to obtain the image quality detection model, and then deploys the image quality detection model for use. When detection may be performed on the image quality of the target element region, category features respectively corresponding to the target element region and a plurality of preset image quality categories are input to the image quality detection model, and feature extraction is performed by using a feature extraction network in the image quality detection model, to obtain a feature vector of a corresponding image, for example, a current region feature is obtained. A feature comparison operation is respectively performed on the current region feature and the category features respectively corresponding to the plurality of preset image quality categories. In other words, the matching degree between the current region feature and each category feature is calculated, and the similarity is calculated by using a spatial norm matching algorithm. In other words, the quadratic sum of distance differences of the same feature bit is calculated, to obtain the matching degrees. Finally, the preset image quality category corresponding to the category feature with the largest matching degree is selected as the target region quality category of the target element region.

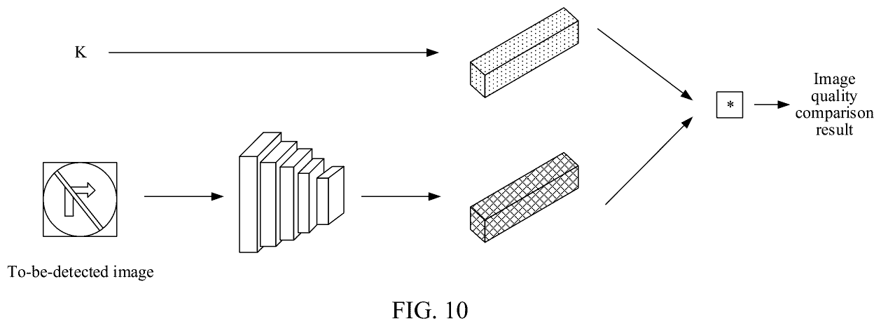

In some embodiments, FIG. 10 is a schematic framework diagram of an image quality detection model. The input image and the category features respectively corresponding to the plurality of preset image quality categories are input to the image quality detection model. The image quality detection model first extracts a current feature of the input image. The input image may be an image corresponding to the target element region. The current feature is compared with the category features respectively corresponding to the plurality of preset image quality categories. In other words, the similarity between the current feature and each category feature is calculated, the target category feature corresponding to the largest similarity is selected, and the preset image quality category corresponding to the target category feature is used as the image quality category corresponding to the input image, to obtain an image quality comparison result. Finally, the image quality category corresponding to the input image is used as an output of the image quality detection model. In other words, the image quality comparison result is obtained through image quality comparison, to obtain the quality category of the image, thereby improving the accuracy of the image quality detection.

In some embodiments, the category features respectively corresponding to the target element region and the plurality of preset image quality categories are input to the image quality detection model, and then the target region quality category of the target element region is obtained through quick detection by using the trained image quality detection model, thereby improving efficiency of obtaining the target region quality category.

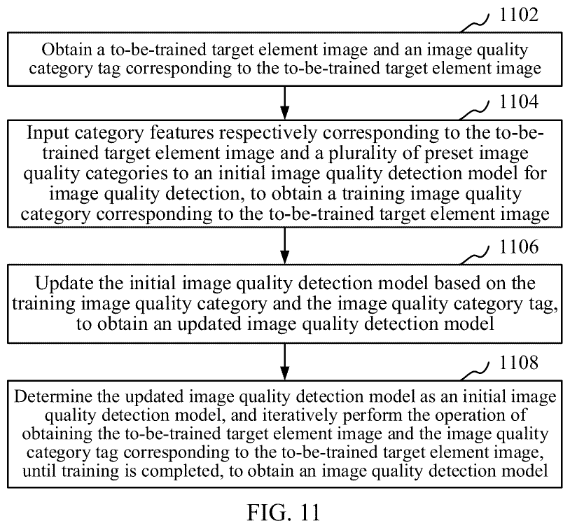

In some embodiments, as shown in FIG. 11, training the image quality detection model include the following operations:

1102: Obtain a to-be-trained target element image and a corresponding image quality category tag.

The to-be-trained target element image is a target element image used during training, and is an image including only the target element. The image quality category tag is a tag of an image quality category corresponding to the to-be-trained target element image. The image quality category tag may be manually pre-marked, or may be obtained by pre-calculating a clear degree of the to-be-trained target element image, and automatically marking based on the clear degree. The image quality category tag may include a clear image tag and a blurry image tag, and the to-be-trained target element image may include a clear target element image and a blurry target element image.

The server may obtain the to-be-trained target element image and the corresponding image quality category tag from the database. The server may obtain the to-be-trained target element image and the corresponding image quality category tag from the serving party providing the data service. The server may obtain the to-be-trained target element image and the corresponding image quality category tag that are uploaded by the terminal.

1104: Input category features respectively corresponding to the to-be-trained target element image and the plurality of preset image quality categories to an initial image quality detection model for image quality detection, to obtain a training image quality category corresponding to the to-be-trained target element image.

The initial image quality detection model is an image quality detection model with an initialized model parameter, and the image quality detection model is established by using a neural network. The training region quality category is a quality category corresponding to the to-be-trained target element image and obtained during training.

The to-be-trained target element image and the reference region features corresponding to the quality categories are input to the initial image quality detection model. The initial image quality detection model extracts a feature of the to-be-trained target element image by using the initialized model parameter, calculates, by using the distance similarity algorithm, respective matching degrees between the extracted feature and the category features respectively corresponding to the plurality of preset image quality categories, and then determines a quality category corresponding to a category feature with a largest matching degree as the training image quality category corresponding to the to-be-trained target element image.

1106: Update the initial image quality detection model based on the training image quality category and the image quality category tag, to obtain an updated image quality detection model.

1108: Determine the updated image quality detection model as an initial image quality detection model, and iteratively perform the operation of obtaining the to-be-trained target element image and the image quality category tag corresponding to the to-be-trained target element image, until training is completed, to obtain the image quality detection model.

The server may calculate a difference between the training region quality category and the image quality category tag by using a classification loss function, to obtain training loss information. The classification loss function may be a cross-entropy loss function. The model parameter in the initial image quality detection model is inversely updated through the gradient descent algorithm by using the training loss information. When the update of the model parameter is completed, the updated image quality detection model is obtained. The updated image quality detection model is determined as the initial image quality detection model, and the operation of obtaining the to-be-trained target element image and the image quality category tag corresponding to the to-be-trained target element image is iteratively performed, until training is completed. The trained initial image quality detection model is used as the image quality detection model finally obtained through training. Completion of training may be that the training is completed when the training reaches a maximum quantity of iterations, or the training is completed when the training loss information reaches a loss threshold, or the training is completed when the model parameters converge.

In some embodiments, the initial image quality detection model is trained by using the to-be-trained target element image, the image quality category tag, and the category features respectively corresponding to the plurality of preset image quality categories. When training is completed, the image quality detection model is obtained. In other words, the initial image quality detection model is iteratively updated by using the training image quality category and the image quality category tag, thereby improving the accuracy of the obtained image quality detection model.

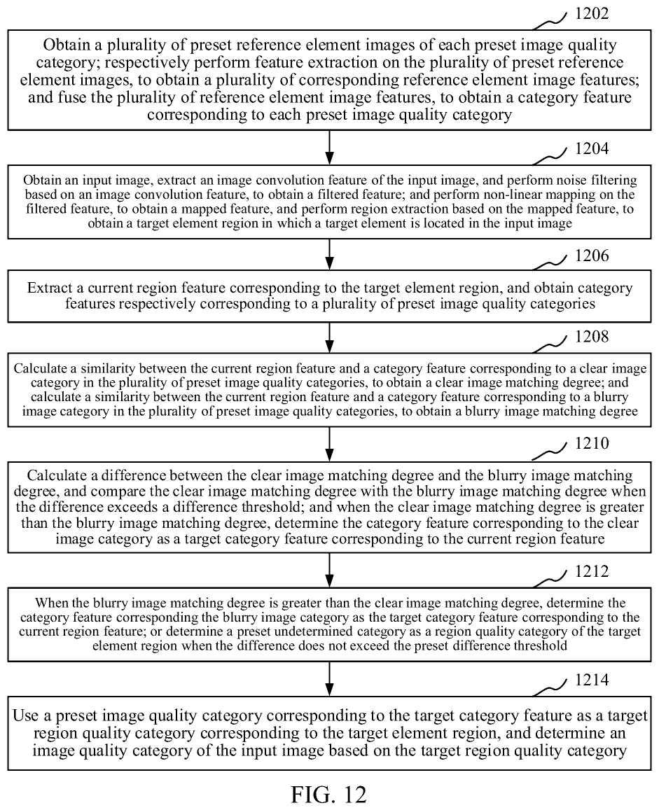

In some embodiments, FIG. 12 is a schematic flowchart of an image quality detection method. The method is performed by a computer device, and ally includes the following operations.

1202: Obtain a plurality of preset reference element images of each preset image quality category; respectively perform feature extraction on the plurality of preset reference element images, to obtain a plurality of corresponding reference element image features; and fuse the plurality of reference element image features, to obtain a category feature corresponding to each preset image quality category.

1204: Obtain an input image, extract an image convolution feature of the input image, and perform noise filtering based on the image convolution feature, to obtain a filtered feature; and perform non-linear mapping on the filtered feature, to obtain a mapped feature, and perform region extraction based on the mapped feature, to obtain a target element region in which a target element is located in the input image.

1206: Extract a current region feature corresponding to the target element region, and obtain category features respectively corresponding to a plurality of preset image quality categories.

1208. Calculate a similarity between the current region feature and a category feature corresponding to a clear image category in the plurality of preset image quality categories, to obtain a clear image matching degree; and calculate a similarity between the current region feature and a category feature corresponding to a blurry image category in the plurality of preset image quality categories, to obtain a blurry image matching degree.

1210: Calculate a difference between the clear image matching degree and the blurry image matching degree, and compare the clear image matching degree with the blurry image matching degree when the difference exceeds a difference threshold; and when the clear image matching degree is greater than the blurry image matching degree, determine the category feature corresponding to the clear image category as the target category feature corresponding to the current region feature.

1212: When the blurry image matching degree is greater than the clear image matching degree, determine the category feature corresponding the blurry image category as the target category feature corresponding to the current region feature; and determine a preset undetermined category as a region quality category of the target element region when the difference does not exceed the preset difference threshold.

1214: Use a preset image quality category corresponding to the target category feature as a target region quality category corresponding to the target element region, and determine an image quality category of the input image based on the target region quality category.

In some embodiments, the current region feature corresponding to the target element region of the input image is compared with the category feature corresponding to each preset image quality category, to determine a matched target category feature, the preset image quality category corresponding to the matched target category feature is used as the region quality category of the target element region, and the image quality category of the input image is determined based on the region quality category of the target element region, thereby improving the accuracy of the obtained image quality category.

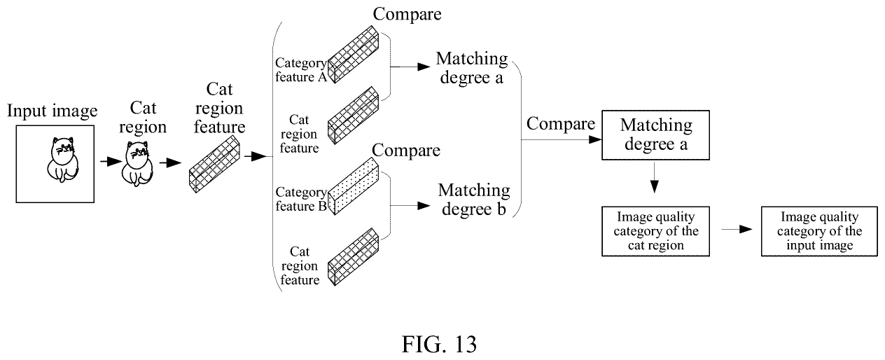

In some embodiments, FIG. 13 is a schematic architectural diagram of an image quality detection method. The server obtains an input image, and a region of interest in the input image is a cat region. The target element is a cat. Recognition and segmentation are performed on the cat region of the input image, to obtain the cat region. A cat region feature of the cat region is then extracted. A category feature A corresponding to the clear image category and a category feature B corresponding to the blurry image category are obtained, and then the cat region feature is respectively compared with the category feature A and the category feature B one by one, to obtain a matching degree a between the cat region feature and the category feature A, and obtain a matching degree b between the cat region feature and the category feature B. The matching degree a is compared with the matching degree b, and when the matching degree a is greater than the matching degree b, the category feature A is used as the target category feature corresponding to the cat region feature. The server uses the clear image category corresponding to the target category feature, for example, the category feature A, as the image quality category of the cat area, and determines that the image quality category of the input image is the clear image category based on the image quality category of the cat region, thereby improving accuracy of the obtained image quality category.

In some embodiments, the input image includes a road image, and the image quality detection method further includes the following operations:
when an image quality category of the road image is the blurry image category, filtering the road image; and when the image quality category of the road image is the clear image category, obtaining a to-be-updated road map, and updating the to-be-updated road map based on the road image, to obtain an updated road map.

In some embodiments, the server may collect a road image and recognize a road sign in the road image, to obtain a road sign region of the road sign in the road image; and extract a road sign feature of the road sign region, and obtain category features respectively corresponding to a plurality of preset image quality categories. The road sign feature is compared with each category feature, to obtain a matching degree between the road sign feature and each category feature. A target category feature corresponding to the road sign feature is determined from the category features based on the matching degrees. The preset image quality category corresponding to the target category feature is used as a region quality category of the road sign region, and the quality category of the road sign region is used as an image quality category of the road image. When the image quality category of the road image is the blurry image category, the road image is filtered. When the image quality category of the road image is the clear image category, the to-be-updated road map is obtained, and the to-be-updated road map is updated based on the road image, to obtain the updated road map. In other words, when the road map is updated, the collected road image of the blurry image category is filtered, and then the road map is updated by using the collected road image of the clear image category to avoid a blurry road image in the updated road map, to improve accuracy of updating the road map.

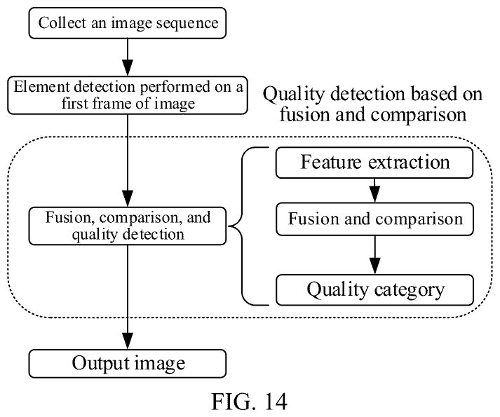

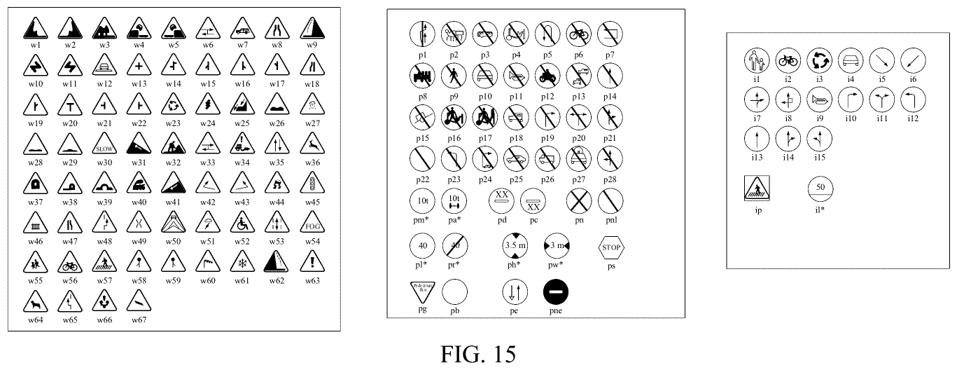

In some embodiments, the image quality detection method is applied to a map update scenario. When road image data in a map is updated, the server collects the road image by using an image collection device. Image quality detection is then performed on the collected road image. FIG. 14 is a schematic framework diagram of performing image quality detection on a road image. The server obtains a collected road image sequence, and then performs image quality detection starting from the first frame of road image. When the image quality detection is performed, target element detection is first performed on the first frame of road image. The target element may be a sign in the road image, to obtain the sign image in the first frame of road image. The image quality detection is then performed on the sign image. The server first obtains a category notification corresponding to each preset image quality category. The category feature is obtained by performing feature extraction on sign images corresponding to a preset image quality category, to obtain a reference element image feature of each sign image, and fusing reference element image features of all sign images of the preset image quality category. FIG. 15 is a schematic diagram of sign images. The plurality of preset image quality categories include the blurry image category and the clear image category. The server obtains a plurality of sign images of the blurry image category and a plurality of sign images of the clear image category, and each sign image represents a corresponding traffic element. Features corresponding to the plurality of sign images of the blurry image category are extracted, and then all the features of the blurry image category are spliced and then fused by using a convolutional neural network, to obtain the category feature corresponding to the blurry image category. Features corresponding to the plurality of sign images of the clear image category are extracted, and then all the features of the clear image category are spliced and then fused by using the convolutional neural network, to obtain the category feature corresponding to the clear image category.

The server extracts a feature of the sign image obtained from the first frame of image, to obtain the current region feature. Matching is performed on the current region feature with the category features corresponding to the plurality of preset image quality categories. In other words, a similarity between the current region feature and the category feature corresponding to each preset image quality category is calculated, and the preset image quality category corresponding to a largest similarity is selected as the preset image quality category to which the sign image belongs. For example, the preset image quality category corresponding to the largest similarity may be the blurry image category. Based on the preset image quality category to which the sign image belongs, the preset image quality category to which the first frame of image belongs is the blurry image category. The server sequentially traverses each frame of road image in the collected image sequence, to obtain the preset image quality category to which each frame of road image belongs. The preset image quality category may be the blurry image category or the clear image category. Accuracy of road image quality detection is improved. The server screens the road images collected in the road image sequence, and filters out the road image of the blurry image category, to obtain the road image of the clear image category. In other words, the road image of the clear image category is used as a road image of which image quality detection succeeds, and then the road image of which image quality detection succeeds is used as a road image for subsequent task processing. For example, the road image of which image quality detection succeeds is used to update a road image in map data.

In some embodiments, the image quality detection method may also be applied to a scenario in which map images are updated in batches. The server collects an image of a target road by using an image collection device, to obtain a road image sequence. Each road image in the road image sequence may be an image including map elements on a target road, such as a traffic restriction intersection, a speed limiting sign, and an electronic eye. Batch detection may be performed on each road image in the road image sequence. In other words, the image quality detection is simultaneously performed on each road image in the road image sequence. In other words, a feature of each road image is simultaneously extracted, to obtain each road image feature. Matching is performed between each road image feature and a category feature corresponding to each preset image quality category. In other words, a similarity between each road image feature and the category feature corresponding to each preset image quality category is calculated. A preset image quality category corresponding to a largest similarity is selected as a preset image quality category to which the road image belongs, to obtain an image quality detection result of the batch detection, which may include a road image of the clear image category or a road image of the blurry image category. Finally, each target road image corresponding to the clear image category is obtained from the road image sequence, and stored historical map images of the target road are updated in batches. In other words, each historical map image of the target road is updated to each target road image of the clear image category, to obtain an updated map image of the target road.

In some embodiments, the server may perform automatic update on the map image based on a time period. The server triggers an event of automatic update of the map image when detecting that current time reaches the time period. In response to the event of automatic update of the map image, the server collects, by using the image collection device, map images that may be updated in batches, then performs image quality detection on the map images, filters out a blurry map image with a blurry image from the map images, to obtain clear target map images, and then performs automatic update by using the target map images, replaces a historically stored map image, to obtain an updated map image.

In some embodiments, the image quality detection method is applied to a facial recognition scenario. For example,
the server collects a person image, detects a face in the collected person image, to obtain a current face image, and performs feature extraction on the current face image, to obtain a current face image feature. The server obtains a category feature corresponding to a blurry face image category and a category feature corresponding to a clear face image category that are stored in a database. A similarity between the current face image feature and the category feature corresponding to the blurry face image category is calculated, and a similarity between the current face image feature and the category feature corresponding to the clear face image category is calculated at the same time. When the similarity between the category feature of the clear face image category and the current face image feature of the current face image is high, an image quality detection result corresponding to the current face image is a result of the clear image category. Facial recognition may be performed on the current face image, to obtain corresponding face information through recognition. When the similarity between the category feature of the blurry face image and the current face image feature of the current face image is high, the image quality detection result corresponding to the current face image is a result of the blurry image category. Facial recognition cannot be normally performed by using a blurry face image. The server may obtain a collected face image again and perform image quality detection, and performs facial recognition on the face image to obtain a facial recognition result until obtaining a clear face image.

In some embodiments, the image quality detection method is applied to a video media platform. For example,
when obtaining a video or a picture uploaded by a user, a video or picture media platform first performs image quality detection on the video or the picture, in other words, performs image quality detection on a video frame, for example, may detect a target object in the video frame, to obtain a target object region, and then extracts an object feature corresponding to the target object region. The server obtains category features respectively corresponding to a clear target object image category and a blurry target object image category, calculates a similarity between the current object feature and each category feature, compares the similarities, uses a preset image quality category corresponding to a larger similarity as a preset image quality category to which the target object region belongs, and then determines the preset image quality category to which the video frame belongs based on the preset image quality category to which the target object region belongs. When the preset image quality category of the video frame is the blurry image category, the image quality detection fails. The server may generate image quality prompt information indicating that the image is blurry, and send the image quality prompt information to a terminal corresponding to the user and display the image quality prompt information, so that the user may upload a video satisfying an image quality requirement of the video media platform again. When the video frame is of the clear image category, the image quality detection succeeds. The server detects image quality of all video frames in the video. When image quality categories of all the video frames are the clear image category, the image quality detection of the video succeeds. The server may receive the video uploaded by the user, and post the uploaded video on the video media platform. The image quality detection method may also be applied to a picture media platform, to detect image quality of a picture uploaded by a user, and post the picture uploaded by the user on the platform when the image quality detection succeeds.

Although the steps are displayed sequentially according to the instructions of the arrows in the flowcharts of some embodiments, these steps are not necessarily performed sequentially according to the sequence instructed by the arrows. Unless otherwise indicated, execution of the steps is not strictly limited, and the steps may be performed in other sequences. Moreover, at least some of the steps in some embodiments may include a plurality of steps or a plurality of stages. The steps or stages are not necessarily performed at the same moment but may be performed at different moments. Execution of the steps or stages is not necessarily sequentially performed, but may be performed alternately with other steps or at least some of steps or stages of other steps, for example.

Some embodiments further provide an image quality detection apparatus configured to implement the image quality detection method. Some embodiments solution provided by the apparatus for resolving a problem is similar to some embodiments solution recorded in the foregoing method. For implementation details of the image quality detection apparatus provided below, reference may be made to the descriptions of the image quality detection method above.

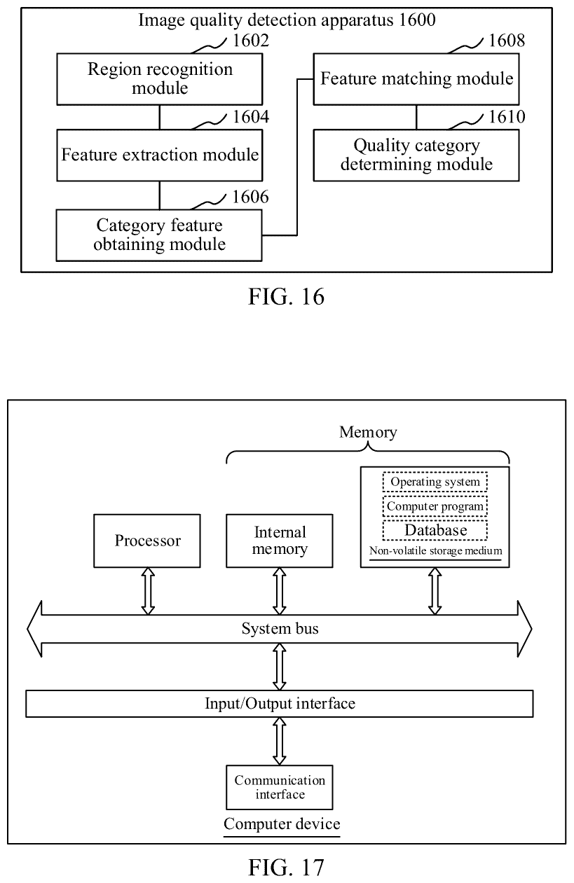

In some embodiments, as shown in FIG. 16, an image quality detection apparatus 1600 is provided, including: a region recognition module 1602, a feature extraction module 1604, a category feature obtaining module 1606, a feature matching module 1608, and a quality category determining module 1610.

The region recognition module 1602 is configured to obtain an input image, and recognize a target element in the input image, to obtain a target element region in which the target element is located in the input image.

The feature extraction module 1604 is configured to extract a current region feature corresponding to the target element region.

The category feature obtaining module 1606 is configured to: obtain category features respectively corresponding to a plurality of preset image quality categories, where the category feature is obtained by respectively performing feature extraction on a plurality of preset reference element images of a preset image quality category to obtain a plurality of corresponding reference element image features and fusing the plurality of reference element image features.

The feature matching module 1608 is configured to: compare the current region feature with each category feature respectively, to obtain a matching degree between the current region feature and the category feature, and determine a target category feature corresponding to the current region feature from a plurality of category features based on the matching degrees.

The quality category determining module 1610 is configured to: output a preset image quality category corresponding to the target category feature as a target region quality category of the target element region, and determine the image quality category of the input image based on the target region quality category.

In some embodiments, the image quality detection apparatus 1600 further includes:
a feature fusion module, configured to: obtain a plurality of preset reference element images of a preset image quality category; respectively perform feature extraction on the plurality of preset reference element images, to obtain a plurality of corresponding reference element image features; and fuse the plurality of reference element image features, to obtain a category feature corresponding to the preset image quality category.

In some embodiments, the feature fusion module is further configured to: splice the plurality of reference element image features, to obtain a spliced feature; and perform a convolution operation based on the spliced feature, to obtain the category feature corresponding to the preset image quality category.

In some embodiments, the image quality detection apparatus 1600 further includes:
a model fusion module, configured to: obtain a trained image feature extraction model, and respectively input the plurality of reference element images to the image feature extraction model; respectively perform feature extraction on the plurality of reference element images by using a feature extraction network in the image feature extraction model, to obtain a plurality of corresponding reference element image features; and fuse the plurality of reference element image features by using a feature fusion network in the image feature extraction model, to obtain the category feature corresponding to the preset image quality category.

In some embodiments, the image quality detection apparatus 1600 further includes:
a model training module, configured to: obtain training images and training category tags corresponding to the training images, and input the training images to an initial image classification model; respectively perform feature extraction on the training images by using an initial feature extraction network in the initial image classification model, to obtain training image features; fuse the training image features by using an initial feature fusion network in the initial image classification model, to obtain a training fusion feature; perform image classification on the training fusion feature by using an initial classification network in the initial image classification model, to obtain an image training category; update the initial image classification model based on the training category tag and the image training category, to obtain an updated image classification model; determine the updated image classification model as an initial image classification model, and iteratively perform the operation of obtaining the training images and the training category tags corresponding to the training images and inputting the training images to the initial image classification model until training is completed, to obtain a target image classification model; and obtain the image feature extraction model based on a target feature extraction network and a target feature fusion network in the target image classification model.

In some embodiments, the region recognition module 1602 is further configured to: extract an image convolution feature of the input image, and perform noise filtering based on the image convolution feature, to obtain a filtered feature; and perform non-linear mapping on the filtered feature, to obtain a mapped feature, and perform target element region extraction based on the mapped feature, to obtain the target element region in which the target element is located in the input image.

In some embodiments, the feature matching module 1606 is further configured to: calculate a similarity between the current region feature and each category feature, to obtain a matching degree between the current region feature and the category feature; and determine a target matching degree from the matching degrees between the current region feature and the category features, and determine a category feature corresponding to the target matching degree as the target category feature corresponding to the current region feature.

In some embodiments, the plurality of preset image quality categories include a clear image category and a blurry image category; and
the feature matching module 1606 is further configured to: calculate a similarity between the current region feature and a category feature corresponding to the clear image category, to obtain a clear image matching degree corresponding to the clear image category; calculate a similarity between the current region feature and a category feature corresponding to the blurry image category, to obtain a blurry image matching degree corresponding to the blurry image category; and determine, based on a difference between the clear image matching degree and the blurry image matching degree, the target category feature corresponding to the current region feature from the category feature corresponding to the clear image category and the category feature corresponding to the blurry image category.

In some embodiments, the feature matching module 1606 is further configured to: calculate the difference between the clear image matching degree and the blurry image matching degree, and compare the clear image matching degree with the blurry image matching degree when the difference exceeds a preset difference threshold; when the clear image matching degree is greater than the blurry image matching degree, determine the category feature corresponding to the clear image category as the target category feature corresponding to the current region feature; or when the blurry image matching degree is greater than the clear image matching degree, determine the category feature corresponding to the blurry image category as the target category feature corresponding to the current region feature; and determine a preset undetermined category as a target region quality category of the target element region when the difference does not exceed the preset difference threshold.

In some embodiments, at least two target element regions are included; and the quality category determining module 1608 is further configured to: respectively calculate region ratios of the at least two target element regions to the input image, screen the at least two target element regions based on the region ratios to obtain a current target element region, and determine a target region quality category of the current target element region as the image quality category of the input image.

In some embodiments, the image quality detection apparatus 1600 further includes:
a model detection module, configured to: input the target element region and the category features respectively corresponding to the plurality of preset image quality categories to an image quality detection model; and extract a current region feature corresponding to the target element region by using a feature extraction network in the image quality detection model, respectively compare the current region feature with each category feature, to obtain the matching degree between the current region feature and the category feature, determine the target category feature corresponding to the current region feature from the category features based on the matching degrees, and determine the preset image quality category corresponding to the target category feature as the target region quality category of the target element region for output.

In some embodiments, the image quality detection apparatus 1600 further includes:
a detection model training module, configured to: obtain a to-be-trained target element image and a corresponding image quality category tag; input category features respectively corresponding to the to-be-trained target element image and the plurality of preset image quality categories to an initial image quality detection model for image quality detection, to obtain a training image quality category corresponding to the to-be-trained target element image; update the initial image quality detection model based on the training image quality category and the image quality category tag, to obtain an updated image quality detection model; and determine the updated image quality detection model as an initial image quality detection model, and iteratively perform the operation of obtaining the to-be-trained target element image and the image quality category tag corresponding to the to-be-trained target element image, until training is completed, to obtain the image quality detection model.

In some embodiments, the input image includes a road image, and the target element region includes a road sign region; and the image quality detection apparatus 1600 further includes:
a map update module, configured to: when an image quality category of the road image is a blurry image category, filter the road image; and when the image quality category of the road image is the clear image category, obtain a to-be-updated road map, and update the to-be-updated road map based on the road image, to obtain an updated road map.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

In some embodiments, a computer device is provided. The computer device may be a server, and an internal structural diagram thereof may be shown in FIG. 17. The computer device includes a processor, a memory, an input/output (I/O) interface, and a communication interface. The processor, the memory, and the input/output interface are connected through a system bus, and the communication interface is connected to the system bus through the input/output interface. The processor of the computer device is configured to provide computing and control capabilities. The memory of the computer device includes a non-volatile storage medium and an internal memory. The non-volatile storage medium has an operating system, a computer program, and a database stored therein. The internal memory provides an environment for running of the operating system and the computer program in the non-volatile storage medium. The database of the computer device is configured to store input image data, reference region features corresponding to quality categories, and the like. The input/output interface of the computer device is configured to exchange information between the processor and an external device. The communication interface of the computer device is configured to connect to and communicate with an external terminal through a network. When executed by the processor, the computer program implements an image quality detection method.

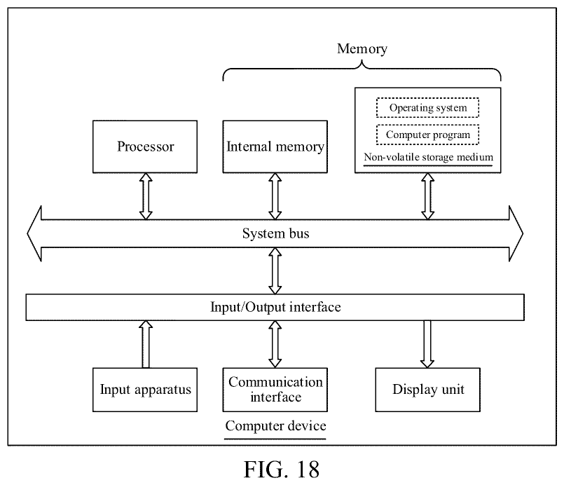

In some embodiments, a computer device is provided. The computer device may be a terminal, and an internal structure diagram thereof may be shown in FIG. 18. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium has an operating system and a computer program stored therein. The internal memory provides an environment for running of the operating system and the computer program in the non-volatile storage medium. The input/output interface of the computer device is configured to exchange information between the processor and an external device. The communication interface of the computer device is configured to perform wired or wireless communication with an external terminal. The wireless communication may be implemented by using Wi-Fi, a mobile cellular network, near field communication (NFC), or another technology. When executed by the processor, the computer program implements an image quality detection method. The display unit of the computer device is configured to form a visually visible picture, and may be a display screen, a projection apparatus, or a virtual reality imaging apparatus. The display screen may be a liquid crystal display screen or an e-ink display screen. The input apparatus of the computer device may be a touch layer covering the display screen, or may be a key, a trackball, or a touchpad disposed on a housing of the computer device, or may be an external keyboard, touchpad, mouse, or the like.

A person skilled in the art may understand that the structures shown in FIG. 17 and FIG. 18 are only block diagrams of a partial structure related to a solution and do not constitute a limitation to the computer device to which the solution in some embodiments is applied. The computer device may include more or fewer components than those shown in the figures, or some components may be combined, or a different component deployment may be used.

In some embodiments, a computer device is provided, including a memory and a processor. The memory has a computer program stored therein. The processor, when executing the computer program, implements the operations in some embodiments.

In some embodiments, a computer-readable storage medium is provided, having a computer program stored therein. The computer program, when executed by a processor, implements the operations in some embodiments.

In some embodiments, a computer program product is provided, including a computer program. The computer program, when executed by a processor, implements the operations in some embodiments.

User information (including, but not limited to, user device information, user personal information, and the like) and data (including, but not limited to, data for analysis, stored data, displayed data, and the like) involved in some embodiments are information and data that are authorized by a user or that are sufficiently authorized by all parties, and collection, use, and processing of related data should comply with related laws and regulations and standards of related countries and regions.

A person of ordinary skill in the art may understand that all or some of procedures of the method in some embodiments may be implemented by a computer program instructing relevant hardware. The program may be stored in a non-volatile computer-readable storage medium. When the program is executed, the procedures of some embodiments may be implemented. References to the memory, the database, or other medium used in some embodiments may all include at least one of a non-volatile or a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random-access memory (MRAM), a ferroelectric random-access memory (FRAM), a phase change memory (PCM), a grapheme memory, and the like. The volatile memory may include a random access memory (RAM), an external cache, or the like. By way of illustration and not limitation, the RAM may be in various forms, such as a static random access memory (SRAM) or a dynamic random access memory (DRAM). The database involved in some embodiments may include at least one of a relational database and a non-relational database. The non-relational database may include a distributed database based on a block chain, and is not limited thereto. The processor involved in some embodiments may be a central processing unit (CPU), a graphic processing unit (GPU), a digital signal processor, a programmable logic unit, a data processing logic unit based on quantum computing, and the like, and is not limited thereto.

Technical features of some embodiments may be combined in different manners to form some embodiments. The combinations of these technical features shall be considered as falling within the scope of the disclosure.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image quality detection method, comprising:
obtaining an input image;
recognizing a target element in the input image, and obtaining a target element region of the input image in which the target element is located;
extracting a current region feature corresponding to the target element region;
obtaining a plurality of category features corresponding to a plurality of preset image quality categories, wherein obtaining a category feature comprises:
performing feature extraction on a plurality of preset reference element images belonging to a preset image quality category to obtain a plurality of reference element image features; and
fusing the plurality of reference element image features to obtain the category feature;
comparing the current region feature with the plurality of category features, to obtain a plurality of matching degrees between the current region feature and the plurality of category features, and determining a target category feature corresponding to the current region feature from the plurality of category features based on the plurality of matching degrees; and
determining a target region quality category of the target element region based on a target preset image quality category corresponding to the target category feature, and outputting a predicted image quality category of the input image based on the target region quality category.

2. The image quality detection method according to claim 1, wherein the obtaining the plurality of category features comprises:
obtaining a first plurality of preset reference element images of a first preset image quality category;
performing feature extraction on the first plurality of preset reference element images, to obtain a first plurality of reference element image features; and
fusing the first plurality of reference element image features, to obtain a first category feature corresponding to the first preset image quality category.

3. The image quality detection method according to claim 2, wherein the fusing the plurality of reference element image features comprises:
splicing the plurality of reference element image features, to obtain a spliced feature; and
performing a convolution operation based on the spliced feature, to obtain the category feature.

4. The image quality detection method according to claim 1, wherein the obtaining the category feature comprises:
obtaining a trained image feature extraction model, and inputting the plurality of preset reference element images into the trained image feature extraction model;
performing feature extraction on the plurality of preset reference element images by using a feature extraction network of the trained image feature extraction model, to obtain a plurality of corresponding reference element image features; and
fusing the plurality of reference element image features by using a feature fusion network of the trained image feature extraction model, to obtain the category feature.

5. The image quality detection method according to claim 4, wherein the obtaining the trained image feature extraction model comprises:
obtaining a first plurality of training images and a first plurality of training category tags corresponding to the first plurality of training images, and inputting the first plurality of training images into a first initial image classification model;
performing feature extraction on the first plurality of training images by using an initial feature extraction network of the first initial image classification model, to obtain a plurality of training image features;
fusing the plurality of training image features by using an initial feature fusion network of the first initial image classification model, to obtain a training fusion feature;
performing image classification on the training fusion feature by using an initial classification network of the first initial image classification model, to obtain an image training category;
updating the first initial image classification model based on the first plurality of training category tags and the image training category, to obtain an updated image classification model;
using the updated image classification model as a second initial image classification model, and iteratively performing, until training is completed, obtaining a second plurality of training images and a second plurality of training category tags corresponding to the second plurality of training images and inputting the second plurality of training images to the second initial image classification model, to obtain a target image classification model; and
obtaining the trained image feature extraction model based on a target feature extraction network and a target feature fusion network in the target image classification model.

6. The image quality detection method according to claim 1, wherein the recognizing the target element in the input image comprises:
extracting an image convolution feature of the input image, and performing noise filtering based on the image convolution feature, to obtain a filtered feature; and
performing non-linear mapping on the filtered feature, to obtain a mapped feature, and performing target element region extraction based on the mapped feature, to obtain the target element region.

7. The image quality detection method according to claim 1, wherein the comparing the current region feature with the plurality of category features comprises:
calculating a plurality of similarities between the current region feature and the plurality of category features, to obtain the plurality of matching degrees; and
determining a target matching degree from the plurality of matching degrees, and determining a first category feature corresponding to the target matching degree as the target category feature corresponding to the current region feature.

8. The image quality detection method according to claim 1, wherein the plurality of preset image quality categories comprise a clear image category and a blurry image category, and
wherein the comparing the current region feature with the plurality of category features comprises:
calculating a first similarity between the current region feature and a first category feature corresponding to the clear image category, to obtain a clear image matching degree corresponding to the clear image category;
calculating a second similarity between the current region feature and a second category feature corresponding to the blurry image category, to obtain a blurry image matching degree corresponding to the blurry image category; and
determining, based on a difference between the clear image matching degree and the blurry image matching degree, the target category feature from the first category feature and the second category feature.

9. The image quality detection method according to claim 8, wherein the determining the target category feature comprises:
calculating the difference between the clear image matching degree and the blurry image matching degree, and, based on the difference exceeding a preset difference threshold, comparing the clear image matching degree with the blurry image matching degree;
based on the clear image matching degree being greater than the blurry image matching degree, determining the first category feature as the target category feature;
based on the blurry image matching degree being greater than the clear image matching degree, determining the second category feature as the target category feature; and
determining a preset undetermined category as the target region quality category based on the difference not exceeding the preset difference threshold.

10. The image quality detection method according to claim 1, wherein the input image comprises a plurality of target element regions, and
wherein the outputting the predicted image quality category comprises:
calculating a plurality of region ratios from a plurality of areas of the plurality of target element regions to a whole image area of the input image;
screening the plurality of target element regions based on the plurality of region ratios to obtain a current target element region; and
determining a current target region quality category of the current target element region as the predicted image quality category.

11. An image quality detection apparatus, comprising:
at least one memory configured to store computer program code; and
at least one processor configured to read the program code and operate as instructed by the program code, the program code comprising:
region recognition code configured to cause at least one of the at least one processor to:
obtain an input image; and
recognize a target element in the input image, and obtain a target element region of the input image in which the target element is located;
feature extraction code configured to extract a current region feature corresponding to the target element region;
category feature obtaining code configured to cause at least one of the at least one processor to: obtain a plurality of category features corresponding to a plurality of preset image quality categories, wherein a category feature is obtained by:
performing feature extraction on a plurality of preset reference element images of a preset image quality category to obtain a plurality of reference element image features; and
fusing the plurality of reference element image features to obtain the category feature;
feature matching code configured to cause at least one of the at least one processor to: compare the current region feature with the plurality of category features, to obtain a plurality of matching degrees between the current region feature and the plurality of category features, and determine a target category feature corresponding to the current region feature from the plurality of category features based on the plurality of matching degrees; and
quality category determining code configured to cause at least one of the at least one processor to: determine a target region quality category of the target element region based on a target preset image quality category corresponding to the target category feature, and output a predicted image quality category of the input image based on the target region quality category.

12. The image quality detection apparatus according to claim 11, wherein the program code further comprises feature fusion code configured to cause at least one of the at least one processor to:
obtain a first plurality of preset reference element images of a first preset image quality category;
perform feature extraction on the first plurality of preset reference element images, to obtain a first plurality of reference element image features; and
fuse the first plurality of reference element image features, to obtain a first category feature corresponding to the first preset image quality category.

13. The image quality detection apparatus according to claim 12, wherein the feature fusion code is further configured to cause at least one of the at least one processor to: splice the plurality of reference element image features, to obtain a spliced feature; and perform a convolution operation based on the spliced feature, to obtain the category feature.

14. The image quality detection apparatus according to claim 11, wherein the program code further comprises model fusion code configured to cause at least one of the at least one processor to:
obtain a trained image feature extraction model, and input the plurality of preset reference element images into the trained image feature extraction model;
perform feature extraction on the plurality of preset reference element images by using a feature extraction network of the trained image feature extraction model, to obtain a plurality of corresponding reference element image features; and
fuse the plurality of reference element image features by using a feature fusion network of the trained image feature extraction model, to obtain the category feature.

15. The image quality detection apparatus according to claim 14, wherein the program code further comprises model training code configured to cause at least one of the at least one processor to:
obtain a first plurality of training images and a first plurality of training category tags corresponding to the first plurality of training images, and input the first plurality of training images into a first initial image classification model;
perform feature extraction on the first plurality of training images by using an initial feature extraction network of the first initial image classification model, to obtain a plurality of training image features;
fuse the plurality of training image features by using an initial feature fusion network of the first initial image classification model, to obtain a training fusion feature;
perform image classification on the training fusion feature by using an initial classification network of the first initial image classification model, to obtain an image training category;
update the first initial image classification model based on the first plurality of training category tags and the image training category, to obtain an updated image classification model;
use the updated image classification model as a second initial image classification model, and iteratively perform, until training is completed, obtaining a second plurality of training images and a second plurality of training category tags corresponding to the second plurality of training images and inputting the second plurality of training images to the second initial image classification model, to obtain a target image classification model; and
obtain the trained image feature extraction model based on a target feature extraction network and a target feature fusion network in the target image classification model.

16. The image quality detection apparatus according to claim 11, wherein the region recognition code is further configured to cause at least one of the at least one processor to:
extract an image convolution feature of the input image, and perform noise filtering based on the image convolution feature, to obtain a filtered feature; and
perform non-linear mapping on the filtered feature, to obtain a mapped feature, and perform target element region extraction based on the mapped feature, to obtain the target element region.

17. The image quality detection apparatus according to claim 11, wherein the feature matching code is further configured to cause at least one of the at least one processor to:
calculate a plurality of similarities between the current region feature and the plurality of category features, to obtain the plurality of matching degrees; and
determine a target matching degree from the plurality of matching degrees, and determine a first category feature corresponding to the target matching degree as the target category feature corresponding to the current region feature.

18. The image quality detection apparatus according to claim 11, wherein the plurality of preset image quality categories comprise a clear image category and a blurry image category, and
wherein the feature matching code is further configured to cause at least one of the at least one processor to: calculate a first similarity between the current region feature and a first category feature corresponding to the clear image category, to obtain a clear image matching degree corresponding to the clear image category;
calculate a second similarity between the current region feature and a second category feature corresponding to the blurry image category, to obtain a blurry image matching degree corresponding to the blurry image category; and
determine, based on a difference between the clear image matching degree and the blurry image matching degree, the target category feature from the first category feature and the second category feature.

19. The image quality detection apparatus according to claim 18, wherein the feature matching code is further configured to cause at least one of the at least one processor to:
calculate the difference between the clear image matching degree and the blurry image matching degree, and, based on the difference exceeding a preset difference threshold, compare the clear image matching degree with the blurry image matching degree;
based on the clear image matching degree being greater than the blurry image matching degree, determine the first category feature as the target category feature;
based on the blurry image matching degree being greater than the clear image matching degree, determine the second category feature as the target category feature; and
determine a preset undetermined category as the target region quality category based on the difference not exceeding the preset difference threshold.

20. A non-transitory computer-readable storage medium, storing computer code which, when executed by at least one processor, causes the at least one processor to at least:
obtain an input image;
recognize a target element in the input image, and obtain a target element region of the input image in which the target element is located;
extract a current region feature corresponding to the target element region;
obtain a plurality of category features corresponding to a plurality of preset image quality categories, wherein a category feature is obtained by:
performing feature extraction on a plurality of preset reference element images of a preset image quality category to obtain a plurality of reference element image features; and
fusing the plurality of reference element image features to obtain the category feature;
compare the current region feature with the plurality of category features, to obtain a plurality of matching degrees between the current region feature and the plurality of category features, and determine a target category feature corresponding to the current region feature from the plurality of category features based on the plurality of matching degrees; and
determine a target region quality category of the target element region based on a preset image quality category corresponding to the target category feature, and output a predicted image quality category of the input image based on the target region quality category.
